(19) United States
(12) Patent Application Publication
(10) Pub. No.: US 2022/0192188 A1
(43) Pub. Date: Jun. 23, 2022

(54) HIGH SPREADING ULV FORMULATIONS FOR HERBICIDES

(71) Applicant: Bayer Aktiengesellschaft, Leverkusen (DE)

(72) Inventors: Arno RATSCHINSKI, Düsseldorf (DE); Andreas RÖCHLING, Langenfeld (DE); Malcolm FAERS, Düsseldorf (DE); Emilia HILZ, Haan (DE); Elisabech ASMUS, Pösbach (DE); Udo BICKERS, Köln (DE)

(73) Assignee: Bayer Aktiengesellschaft, Leverkusen (DE)

(21) Appl. No.: 17/595,080

(22) PCT Filed: May 8, 2020
(86) PCT No.: PCT/EP2020/062908

§ 371 Date: Nov. 8, 2021

(30) Foreign Application Priority Data
May 8, 2019 (EP) 19173402.9
May 8, 2019 (EP) 19173403.7
May 8, 2019 (EP) 19173404.5

(51) Int. Cl. A01N 25/30; A01N 25/06

(52) U.S. Cl. CPC A01N 25/30; A01N 43/56; A01N 25/06

(57) ABSTRACT

The present invention relates to agrochemical compositions: their use for foliar application; their use at low spray volumes; their use by unmanned aerial systems (UAS), unmanned guided vehicles (UGV), and tractor mounted boom sprayers fitted with conventional nozzles but also pulse width modulation spray nozzles or rotating disc droplet applicators; and their application for controlling agricultural pests, weeds or diseases, in particular on waxy leaves.

The present invention relates to agrochemical compositions: their use for foliar application; their use at low spray volumes; their use by unmanned aerial systems (UAS), unmanned guided vehicles (UGV), and tractor mounted boom sprayers fitted with conventional nozzles but also pulse width modulation spray nozzles or rotating disc droplet applicators; and their application for controlling agricultural pests, weeds or diseases, in particular on waxy leaves.

Modern agriculture faces many challenges in producing sufficient food in a safe and sustainable way. There is therefore a need to utilise crop protection products to enhance the safety, quality and yield while minimising the impact to the environment and agricultural land. Many crop protection products, whether chemical or biological, are normally applied at relatively high spray volumes, for example in selected cases >50 L/ha, and often >150-400 L/ha. A consequence of this is that much energy must be expended to carry the high volume of spray liquid and then apply it to the crop by spray application. This can be performed by large tractors which on account of their weight and also the weight of the spray liquid produce CO₂ from the mechanical work involved and also cause detrimental compaction of the soil, affecting root growth, health and yield of the plants, as well as the energy subsequently expended in remediating these effects.

There is a need for a solution that significantly reduces the high volumes of spray liquid and reduces the weight of the equipment required to apply the product.

In agriculture, low spray volume application technologies including unmanned aerial systems (UAS), unmanned guided vehicles (UGV), and tractor mounted boom sprayers fitted with pulse width modulation spray nozzles or rotating disc droplet applicators are offering farmers solutions to apply products with low spray volumes, typically down to 10 to 20 l/ha or less. These solutions have advantages including for example that they require significantly less water which is important in regions where the supply of water is limited, require less energy to transport and apply the spray liquid, are faster both from quicker filling of the spray tank and faster application, reduce the CO₂ generation from both the reduced volume of spray liquid to transport and from the use of smaller and lighter vehicles, reduced soil compaction damage, and enabling the use of cheaper application systems.

However, Wang et al [Field evaluation of an unmanned aerial vehicle (UAV) sprayer: effect of spray volume on deposition and the control of pests and disease in wheat. Pest Management Science 2019 doi/epdf/10.1002/ps.5321] demonstrated that as the spray volume is decreased from 450 and 225 l/ha to 28.1, 16.8 and 9.0 l/ha, the coverage (% area), number of spray deposits per area, and diameter of the spray deposits as measured on water sensitive paper all decreased (see Table 3 in Wang et al, 2019). In parallel, the biological control efficacy for both wheat aphid control and powdery mildew control decreased at low spray volumes with the greatest decrease observed at 9.0 l/ha, followed by 16.8 l/ha (see FIGS. 6, 7 and 8 in Wang et al, 2019).

There is therefore a need to design formulation systems that overcome the reduction in the coverage and diameter of the spray deposits at low spray volumes even through the number of spray deposits per area is decreasing: as the spray volume decreases, the number of spray droplets per unit area decreases proportionately for the same spray droplet spectra size. This is especially necessary below 25 l/ha, more especially below 17 l/ha, and even more especially at 10 l/ha and below.

The solution is provided by formulations containing a surprising low total amount of applied organosilicone surfactant, below the level normally used and below the level where the organosilicone surfactant is expected to work. Such formulations give increased coverage and increased diameter of spray deposits at low spray volumes. Furthermore, the increased coverage and increased diameter of spray deposits is comparable to the coverage obtained at normal higher spray volumes. Furthermore, the formulations exemplifying the invention are particularly effective on hard to wet leaf surfaces where more conventional spray volumes have poor retention and coverage.

A particular advantage of the invention stemming from the low total amount of organosilicone-based surfactant compared to the amount required at normal higher spray volumes is lower cost of formulations and their ease of production. Further advantages include improved formulation stability and simplified manufacture, less cost of goods as well as less impact on the environment.

The use of organosilicone-based surfactants as tank mix adjuvants has existed for many years, with the recognition that lower spray volumes can be advantageous. R. Gaskin et al [Adjuvant prescriptions to lower water volumes and improve disease control in vineyards, ISAA 2004 proceedings; R. Gaskin et al, New adjuvant technology for pesticide use on wine grapes, New Zealand Plant Protection 55:154-158 (2002); and R. Gaskin et al, Use of a superspreader adjuvant to reduce spray application volumes on avocados, New Zealand Avocado Growers' Association Annual Research Report 2004. 4:8-12] report that organosilicone-based surfactants can be advantageous to reduces spray volumes. However, these refer to relatively high spray volumes, from 100 to 2500 l/ha, and high adjuvant doses, 100 to 800 gl/ha. They do not show or suggest that organosilicone-based surfactants could offer advantages at very low spray volumes, typically down to 10-20 l/ha, or even below, and also at low doses of surfactant, typically 50 g/h and below.

R. Gaskin et al [Effect of surfactant concentration and spray volume on retention of organosilicone sprays on wheat, Proc. 50th N.Z. Plant Protection Conf. 1997: 139-142] concluded that organosilicone-based surfactants are expected to enhance the retention of pesticide sprays on difficult-to-wet arable species over a wide range of spray application volumes. However, the data only covered 37 to 280 l/ha and only referred to retention pesticide sprays but not to plant coverage or size of the spray deposits. Furthermore, there was no mention of ultro low spray volumes according to the present invention with application volumes down to 10-20 l/ha and in particular embodiments even below this, e.g down to 1-5 l/ha.

All of these refer to tank-mix adjuvants and not to ready to use formulations.

The formulations of the invention, which are most preferably ready to use formulations in contrast to tank mixes, offer the advantage of low spray volumes and thus, low but still effective amounts of active ingredients on the plants by using a higher concentration of organosilicone in the formulations of the invention as indicated herein resulting due to the low spray volume in a lower abundance in the environment after application.

Formulations, also for tank mixes, known in the prior art containing organosilicone-based surfactants are principally designed for much higher spray volumes and generally contain lower concentrations of organosilicone-based surfactants in the spray broth. Nevertheless, due to the high spray volumes used in the prior art, the total amount of organosilcone surfactant used and therefore in the environment is higher than according to the present invention.

The concentration of the organosilicone surfactant is an important element of the invention, since suitable spreading occurs when a certain minimum concentration of organosilicone surfactant is achieved, normally 0.05% w/w or w/v (these are equivalent since the density of the organosilicone surfactant is approximately 1.0 g/cm³.

For clarifications sake, as it is understood by a skilled person, spreading means the immediate spreading of a droplet on a surface, i.e. in the context of the present invention the surface of the part of a plant such as a leaf.

Therefore, in a spray volume of 500 l/ha as it is used in the prior art, about 250 g/ha of organosilicone surfactant would be required to achieve suitable spreading. Hence, faced with the task to reduce the spray volume, the skilled person would apply the same concentration of organosilicone surfactant in the formulation. For example for a spray volume of 10 l/ha about 5 g/ha (about 0.05% in the spray broth) surfactant would be required. However, at such a low volume with such low concentration of organosilicon surfactant sufficient spreading cannot be achieved (see examples).

In this invention, we have surprisingly found that increasing the concentration of organosilicone surfactant as the spray volume decreases can compensate for the loss in coverage (due to insufficient spreading) from the reduction in spray volume. It was surprisingly found that for every reduction of the spray volume by 50%, the concentration of surfactant should roughly be doubled.

Thus, although the absolute concentration of the organosilicone-surfactant is increased compared to formulations known in the art, the relative total amount per ha can be decreased, which is advantageous, both economically and ecologically, while coverage by and efficacy of the formulation according to the invention is improved, maintained or at least kept at an acceptable level when other benefits of the low volume applications are considered, e.g. less costs of formulation due to less cost of goods, smaller vehicles with less working costs, less compacting of soil etc.

A further part of the invention that allows surprising low total amount of organosilicone-based surfactants to be used is the surface texture of the target weed leaves. Bico et al [Wetting of textured surfaces, Colloids and Surfaces A, 206 (2002) 41-46] have established that compared to smooth surfaces, textured surfaces can enhance the wetting for formulation spray dilutions with a contact angles<90° and reduce the wetting for contact angles>90°.

This is also the case for leaf surfaces, in particular textured leaf surfaces, when sprayed in a method according to the invention resulting in low total amounts (per ha) of organosilicone-based surfactants due to the low spray volumes with formulations according to the invention having a high concentration of the organosilicone surfactant. Remarkably high coverage of the leaf surfaces by the spray liquid, even to a level greater than would be normally be expected, could be demonstrated.

Textured leaf surfaces include leaves containing micron-scale wax crystals on the surface such as wheat, barley, rice, rapeseed, soybean (young plants) and cabbage for example, and leaves with surface textures such as lotus plant leaves for example. The surface texture can be determined by scanning electron microscope (SEM) observations and the leaf wettability determined by measuring the contact angle made by a drop of water on the leaf surface.

In summary, the object of the present invention is to provide a formulation which can be applied in ultra-low volumes, i.e. <20 l/ha, while still providing good leaf coverage, uptake and biological efficacy against herbicides and at the same time reducing the amounts of additional additives applied per ha, as well as a method of using said formulation at ultra-low volumes (<20 l/ha), and the use of said formulation for application in ultra-low volumes as defined above.

While the application on textured leaves is preferred, surprisingly it was found that also on non-textured leaves the formulations according to the instant invention showed good spreading and coverage as well as other properties compared to classical spray application formulations for 200 l/ha.

In one aspect, the present invention is directed to the use of the compositions according to the invention for foliar application.

If not otherwise indicated, % in this application means percent by weight (% w/w).

It is understood that in case of combinations of various components, the percentages of all components of the formulations always sum up to 100.

Further, if not otherwise indicated, the reference “to volume” for carriers indicates that the carrier is added to 1000 ml (11) or to 1000 g (1 kg). For the sake of clarity it is understood that if unclear the density of the formulation is understood as to be 1 g/cm³.

Further, it is understood, that the preferred given ranges of the application volumes or application rates as well as of the respective ingredients as given in the instant specification can be freely combined and all combinations are disclosed herein, however, in a more preferred embodiment, the ingredients are preferably present in the ranges of the same degree of preference, and even more preferred the ingredients are present in the most preferred ranges.

In one aspect, the invention refers to a formulation comprising:
a) One or more active ingredients selected from the group of agrochemically applied herbicides,
b) One or more organosilicone based surfactants (preferably a polyalkyleneoxide modified heptamethyltrisiloxane),
c) one ore more other formulants, and
d) carrier to volume (1 kg or 1 l),
wherein b) is present in 0.5 to 15% by weight.
In a preferred embodiment component a) comprises at least one compound selected from the group of herbicides and one compound selected from the group of safeners.
If not otherwise indicated in the present invention the carrier is usually used to volume (to add up to 11) the formulation. Preferably, the concentration of water in the formulation according to the invention is at least 5% w/w, more preferred at least 10% w/w such as at least 20% w/w, at least 40% w/w, at least 50% w/w, at least 60% w/w, at least 70% w/w and at least 80% w/w.
The formulation is preferably a spray application to be used on weeds.

In a preferred embodiment the formulation of the instant invention comprises
a) One or more active ingredients selected from the group of agrochemically applied herbicides,
b) One or more organosilicone based surfactant (preferably a polyalkyleneoxide modified heptamethyltrisiloxane), and
c1) At least one suitable non-ionic surfactant and/or suitable ionic surfactant.
c2) Optionally, a rheological modifier
c3) Optionally, a suitable antifoam substance
c4) Optionally, suitable other formulants
d) Carrier to volume,
wherein b) is present in 2 to 15% by weight.

In another embodiment at least one of c2, c3 and c4 are mandatory, preferably, at least two of c2, c3 and c4 are mandatory, and in yet another embodiment c2, c3 and c4 are mandatory.

In a preferred embodiment component a) is preferably present in an amount from 1 to 55% by weight, preferably from 2 to 20% by weight, and most preferred from 3 to 20% by weight.

In an alternative embodiment a) is present from 3 to 10% by weight, preferably for thiencarbazone, iodosulfuron-methyl-sodium, mesosulfuron-methyl-sodium and glyphosate as at least one herbicide.

In another embodiment a) is present from 5 to 20% by weight, preferably for tembotrione, fenoxaprop-P-ethyl, acetochor, bromoxynil-ocatanoate-heptanoate.

In yet another embodiment a) is present from 10 to 20% by weight.

In yet another embodiment a) is present from 40 to 60%, preferably for glyphosate.

In a preferred embodiment component b) is present in 0.5 to 15% by weight, preferably from 0.75 to 12% by weight, and more preferred from 1 to 10% by weight.

In a preferred embodiment the one or more component c) are present in 0.5 to 65% by weight, preferably from 1 to 49.5% by weight, and more preferred from 2 to 37.5% by weight.

In a preferred embodiment the one or more component c1) is present in 0.5 to 20% by weight, preferably in 1 to 17.5 by weight and most preferred in 2 to 15 by weight.

In a preferred embodiment the one or more component c2) is present in 0 to 20% by weight, preferably in 0 to 15 by weight and most preferred in 0 to 10 by weight.

In a preferred embodiment the one or more component c3) is present in 0 to 5% by weight, preferably in 0 to 2 by weight and most preferred in 0 to 0.5 by weight.

In a preferred embodiment the one or more component c4) is present in 0 to 20% by weight, preferably in 0 to 15 by weight and most preferred in 0 to 12 by weight.

In case c2 is mandatory, it is present in 0.1 to 20% by weight.

In case c3 is mandatory, it is present in 0.05 to 5% by weight.

In case c4 is mandatory, it is present in 0.1 to 20% by weight.

In a preferred embodiment the herbicide is selected from the group comprising acetochor, bromoxynil-ocatanoate-heptanoate, fenoxaprop-P-ethyl and tembotrione, and the safener is selected from the group comprising isoxadifen-ethyl and mefenpyr-diethey, wherein the ratio of herbicide to safener is from 3:1 to 1:1, preferably from 2.5:1 to 1.5:1.

In another preferred embodiment the herbicide is selected from the group comprising thiencarbazone-methyl and mesosulfuron-methyl-sodium, and the safener is selected from the group comprising isoxadifen-ethyl and mefenpyr-diethey, wherein the ratio of herbicide to safener is from 1:10 to 1:3, preferably from 1:7 to 1:4.

In yet another preferred embodiment the herbicide is selected from the group comprising glyphosate, and the safener is selected from the group comprising isoxadifen-ethyl and mefenpyr-diethey, wherein the ratio of herbicide to safener is from 60:1 to 40:1.

In one embodiment the formulation comprises the components a) to d) in the following amounts
a) 1 to 55% by weight
b) 0.5 to 15% by weight
c) 0.5 to 65% by weight
d) carrier to volume.

In one embodiment the formulation comprises the components a) to d) in the following amounts
a) 1 to 55% by weight
b) 0.5 to 15% by weight
c1) 0.5 to 20% by weight
c2) 0 to 20% by weight
c3) 0 to 5% by weight
c4) 0 to 20% by weight
d) carrier to volume.

In another embodiment the formulation comprises the components a) to d) in the following amounts
a) 3 to 20% by weight
b) 1 to 10% by weight
c1) 1 to 17.5% by weight
c2) 0 to 15% by weight
c3) 0 to 2% by weight
c4) 0 to 15% by weight
d) carrier to volume.

In yet another embodiment the formulation comprises the components a) to c) in the following amounts
a) 1 to 55% by weight
b) 0.5 to 15% by weight
c1) 2 to 37.5% by weight
c2) 0.1 to 20% by weight
c3) 0.05 to 5% by weight
c4) 0.1 to 20% by weight
d) carrier to volume.

As indicated above, component d) is always added to volume, i.e. to 1 l, or to 1 kg, i.e. in the case of weight s the weight % add up to 100.

In a further preferred embodiment of the present invention the formulation consists only of the above described ingredients a) to d) in the specified amounts and ranges.

The instant invention further applies to a method of application of the above referenced formulations, wherein the formulation is applied at a spray volume of between 1 and 20 l/ha, preferably 2 and 15 l/ha, more preferably 5 and 15 l/ha.

More preferred, the instant invention applies to a method of application of the above referenced formulations, wherein the formulation is applied at a spray volume of between 1 and 20 l/ha, preferably 2 and 15 l/ha, more preferably 5 and 15 l/ha,

and the amount of b) is present in 0.5 to 15% by weight, preferably from 0.75 to 12% by weight, and more preferred from 1 to 10% by weight.
wherein in a further preferred embodiment a) is present in an amount from 1 to 55% by weight, preferably from 2 to 20% by weight, and most preferred from 3 to 20% by weight.

In an alternative embodiment a) is present from 1 to 5% by weight.

In another embodiment a) is present from 5 to 20% by weight.

In yet another embodiment a) is present from 40 to 60% by weight.

In another aspect the instant invention applies to a method of application of the above referenced formulations,

wherein the formulation is applied at a spray volume of between 1 and 20 l/ha, preferably 2 and 15 l/ha, more preferably 5 and 15 l/ha, and
wherein preferably the applied amount of a) to the crop is between 2 and 250 g/ha, preferably between 5 and 225 g/ha, and more preferred between 10 and 200 g/ha.

In one embodiment, the with the above indicated method applied amount of a) to the crop is between 2 and 10 g/ha.

In another embodiment, the with the above indicated method applied amount of a) to the crop is between 40 and 110 g/ha.

In one embodiment in the applications described above, the active ingredient (ai) a) is preferably applied from 2 and 250 g/ha, preferably between 5 and 225 g/ha, and more preferred between 10 and 200 g/ha, while correspondingly the organosilicone-surfactant b) is preferably applied from 10 g/ha to 100 g/ha, more preferably from 20 g/ha to 80 g/ha, and most preferred from 40 g/ha to 60 g/ha.

In particular the formulations of the instant invention are useful for application on weeds, plants or crops with textured leaf surfaces.

The corresponding doses of organosilicone surfactant (b) in formulations according to the invention to the applied doses are:

A 2 l/ha liquid formulation delivering:
50 g/ha of organosilicone surfactant contains 25 g/l of surfactant (b),
30 g/ha of organosilicone surfactant contains 15 g/l of surfactant (b),
12 g/ha of organosilicone surfactant contains 6 g/l of surfactant (b),
10 g/ha of organosilicone surfactant contains 5 g/l of surfactant (b).

A 1 l/ha liquid formulation delivering:
50 g/ha of organosilicone surfactant contains 50 g/l of surfactant (b),
30 g/ha of organosilicone surfactant contains 30 g/l of surfactant (b),
12 g/ha of organosilicone surfactant contains 12 g/l of surfactant (b),
10 g/ha of organosilicone surfactant contains 10 g/l of surfactant (b).

A 0.5 l/ha liquid formulation delivering:
50 g/ha of organosilicone surfactant contains 100 g/l of surfactant (b),
30 g/ha of organosilicone surfactant contains 60 g/l of surfactant (b),
12 g/ha of organosilicone surfactant contains 24 g/l of surfactant (b),
10 g/ha of organosilicone surfactant contains 20 g/l of surfactant (b).

A 0.2 l/ha liquid formulation delivering:
50 g/ha of organosilicone surfactant contains 250 g/l of surfactant (b),
30 g/ha of organosilicone surfactant contains 150 g/l of surfactant (b),
12 g/ha of organosilicone surfactant contains 60 g/l of surfactant (b),
10 g/ha of organosilicone surfactant contains 50 g/l of surfactant (b).

A 2 kg/ha solid formulation delivering:
50 g/ha of organosilicone surfactant contains 25 g/kg of surfactant (b),
30 g/ha of organosilicone surfactant contains 15 g/kg of surfactant (b),
12 g/ha of organosilicone surfactant contains 6 g/kg of surfactant (b),
10 g/ha of organosilicone surfactant contains 5 g/kg of surfactant (b).

A 1 kg/ha solid formulation delivering:
50 g/ha of organosilicone surfactant contains 50 g/kg of surfactant (b),
30 g/ha of organosilicone surfactant contains 30 g/kg of surfactant (b),
12 g/ha of organosilicone surfactant contains 12 g/kg of surfactant (b),
10 g/ha of organosilicone surfactant contains 10 g/kg of surfactant (b).

A 0.5 kg/ha solid formulation delivering:
50 g/ha of organosilicone surfactant contains 100 g/kg of surfactant (b),
30 g/ha of organosilicone surfactant contains 60 g/kg of surfactant (b),
12 g/ha of organosilicone surfactant contains 24 g/kg of surfactant (b),
10 g/ha of organosilicone surfactant contains 20 g/kg of surfactant (b).

The concentrations of organosilicone surfactant (b) in formulations that are applied at other dose per hectare rates can be calculated in the same way.

In the context of the present invention, suitable formulation types are by definition suspension concentrates, aqueous suspensions, suspo-emulsions or capsule suspensions, emulsion concentrates, water dispersible granules, oil dispersions, emulsifiable concentrates, dispersible concentrates, preferably suspension concentrates, aqueous suspensions, suspo-emulsions and oil dispersions.

Active ingredients (a) are—add list

The active compounds identified here by their common names are known and are described, for example, in the pesticide handbook (“The Pesticide Manual” 16th Ed., British Crop Protection Council 2012) or can be found on the Internet (e.g. http://www.alanwood.net/pesticides). The classification is based on the current IRAC Mode of Action Classification Scheme at the time of filing of this patent application.

In the context of the present invention safeners are also included in the group of herbicides.

Examples for herbicides are:

Acetochlor, acifluorfen, acifluorfen-sodium, aclonifen, alachlor, allidochlor, alloxydim, alloxydim-sodium, ametryn, amicarbazone, amidochlor, amidosulfuron, 4-amino-3-chloro-5-fluoro-6-(7-fluoro-1H-indol-6-yl)pyridine-2-carboxylic acid, aminocyclopyrachlor, aminocyclopyrachlor-potassium, aminocyclopyrachlor-methyl, aminopyralid, amitrole, ammoniumsulfamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bixlozone, bromacil, bromobutide, bromofenoxim, bromoxynil, bromoxynil-butyrate, -potassium, -heptanoate, and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, 1-{2-chloro-3-[(3-cyclopropyl-5-hydroxy-1-methyl-1H-pyrazol-4-yl)carbonyl]-6-(trifluormethyl)phenyl}piperidin-2-on, 4-{2-chloro-3-[(3,5-dimethyl-1H-pyrazol-1-yl)methyl]-4-(methylsulfonyl)benzoyl}-1,3-dimethyl-1H-pyrazol-5-yl-1,3-dimethyl-1H-pyrazol-4-carboxylat, chlorfenac, chlorfenac-sodium, chlorfenprop, chlorflurenol, chlorflurenol-methyl, chloridazon, chlorimuron, chlorimuron-ethyl, 2-[2-chloro-4-(methylsulfonyl)-3-(morpholin-4-ylmethyl)benzoyl]-3-hydroxycyclohex-2-en-1-on, 4-{2-chloro-4-(methylsulfonyl)-3-[(2,2,2-trifluorethoxy)methyl]benzoyl}-1-ethyl-1H-pyrazol-5-yl-1,3-dimethyl-1H-pyrazol-4-carboxylat, chlorophthalim, chlorotoluron, chlorthal-dimethyl, 3-[5-chloro-4-(trifluormethyl)pyridine-2-yl]-4-hydroxy-1-methylimidazolidine-2-on, chlorsulfuron, cinidon, cinidon-ethyl, cinmethylin, cinosulfuron, clacyfos, clethodim, clodinafop, clodinafop-propargyl, clomazone, clomeprop, clopyralid, cloransulam, cloransulam-methyl, cumyluron, cyanamide, cyanazine, cycloate, cyclopyranil, cyclopyrimorate, cyclosulfamuron, cycloxydim, cyhalofop, cyhalofop-butyl, cyprazine, 2,4-D, 2,4-D-butotyl, -butyl, -dimethylammonium, -diolamin, -ethyl, -2-ethylhexyl, -isobutyl, -isooctyl, -isopropylammonium, -potassium, -triisopropanolammonium, and -trolamine, 2,4-DB, 2,4-DB-butyl, -dimethylammonium, -isooctyl, -potassium, and -sodium, daimuron (dymron), dalapon, dazomet, n-decanol, desmedipham, detosyl-pyrazolate (DTP), dicamba, dichlobenil, dichlorprop, dichlorprop-P, diclofop, diclofop-methyl, diclofop-P-methyl, diclosulam, difenzoquat, diflufenican, diflufenzopyr, diflufenzopyr-sodium, dimefuron, dimepiperate, dimethachlor, dimethametryn, dimethenamid, dimethenamid-P, 3-(2,6-dimethylphenyl)-6-[(2-hydroxy-6-oxocyclohex-1-en-1-yl)carbonyl]-1-methylchinazolin-2,4(1H,3H)-dion, 1,3-dimethyl-4-[2-(methylsulfonyl)-4-(trifluormethyl)benzoyl]-1H-pyrazol-5-yl-1,3-dimethyl-1H-pyrazol-4-carboxylat, dimetrasulfuron, dinitramine, dinoterb, diphenamid, diquat, diquat-dibromid, dithiopyr, diuron, DMPA, DNOC, endothal, EPTC, esprocarb, ethalfluralin, ethametsulfuron, ethametsulfuron-methyl, ethiozin, ethofumesate, ethoxyfen, ethoxyfen-ethyl, ethoxysulfuron, etobenzanid, ethyl-[(3-{2-chloro-4-fluoro-5-[3-methyl-2,6-dioxo-4-(trifluormethyl)-3,6-dihydropyrimidin-1(2H)-yl]phenoxy}pyridin-2-yl)oxy] acetat, F-9960, F-5231, i.e. N-{2-chloro-4-fluoro-5-[4-(3-fluoropropyl)-5-oxo-4,5-dihydro-1H-tetrazol-1-yl]phenyl}ethanesulfonamide, F-7967, i. e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, fluazifop, fluazifop-P, fluazifop-butyl, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, fluro-chloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, -isopropylammonium, -diammonium, -dimethylammonium, -potassium, -sodium, and -trimesium, H-9201, i.e. O-(2,4-dimethyl-6-nitrophenyl) O-ethyl isopropylphosphoramidothioate, halauxifen, halauxifen-methyl, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl) ethyl-(2,4-dichlorophenoxy)acetate, 4-hydroxy-1-methoxy-5-methyl-3-[4-(trifluormethyl)pyridine-2-yl]imidazolidine-2-on, 4-hydroxy-1-methyl-3-[4-(trifluormethyl)pyridine-2-yl]imidazolidine-2-on, (5-hydroxy-1-methyl-1H-pyrazol-4-yl)(3,3,4-trimethyl-1,1-dioxido-2,3-dihydro-1-benzothiophen-5-yl)methanon, 6-[(2-hydroxy-6-oxocyclohex-1-en-1-yl)carbonyl]-1,5-dimethyl-3-(2-methylphenyl)chinazolin-2,4(1H,3H)-dion, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-immonium, imazosulfuron, indanofan, indaziflam, iodosulfuron, iodosulfuron-methyl-sodium, ioxynil, ioxynil-octanoate, -potassium and -sodium, ipfencarbazone, isoproturon, isouron, isoxaben, isoxaflutole, karbutilate, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, keto-spiradox, lactofen, lenacil, linuron, MCPA, MCPA-butotyl, -dimethylammonium, -2-ethylhexyl, -isopropylammonium, -potassium, and -sodium, MCPB, MCPB-methyl, -ethyl, and -sodium, mecoprop, mecoprop-sodium, and -butotyl, mecoprop-P, mecoprop-P-butotyl, -dimethylammonium, -2-ethylhexyl, and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, 2-({2-[(2-methoxyethoxy)methyl]-6-(trifluormethyl)pyridin-3-yl}carbonyl)cyclohexan-1,3-dion, methyl isothiocyanate, 1-methyl-4-[(3,3,4-trimethyl-1,1-dioxido-2,3-dihydro-1-benzothiophen-5-yl)carbonyl]-1H-pyrazol-5-ylpropan-1-sulfonat, metobromuron, metolachlor, S-metolachlor, metosulam, metoxuron, metribuzin, metsulfuron, metsulfuron-methyl, molinat, monolinuron, monosulfuron, monosulfuron-ester, MT-5950, i.e. N-(3-chloro-4-isopropylphenyl)-2-methylpentan amide, NGGC-011, napropamide, NC-310, i.e. [5-(benzyloxy)-1-methyl-1H-pyrazol-4-yl] (2,4-dichlorophenyl)-methanone, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxyfluorfen, paraquat, paraquat dichloride, pebulate, pendimethalin, penoxsulam, pentachlorphenol, pentoxazone, pethoxamid, petroleum oils, phenmedipham, picloram, picolinafen, pinoxaden, piperophos, pretilachlor, primisulfuron, primisulfuron-methyl, prodiamine, profoxydim, prometon, prometryn, propachlor, propanil, propaquizafop, propazine, propham, propisochlor, propoxy-carbazone, propoxycarbazone-sodium, propyrisulfuron, propyzamide, prosulfocarb, prosulfuron, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimi-sulfan, pyrithiobac, pyrithiobac-sodium, pyroxasulfone, pyroxsulam, quinclorac, quinmerac, quino-clamine, quizalofop, quizalofop-ethyl, quizalofop-P, quizalofop-P-ethyl, quizalofop-P-tefuryl, QYM-201, QYR-301, rimsulfuron, saflufenacil, sethoxydim, siduron, simazine, simetryn, SL-261, sulcotrion, sulfentrazone, sulfometuron, sulfometuron-methyl, sulfosulfuron, SYN-523, SYP-249, i.e. 1-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, 2,3,6-TBA, TCA (trichloroacetic acid), TCA-sodium, tebuthiuron, tefuryltrione, tembotrione, tepraloxydim, terbacil, terbucarb, terbumeton, terbuthylazin, terbutryn, tetflupyrolimet, thenylchlor, thiazopyr, thiencarbazone, thiencarbazone-methyl, thifensulfuron, thifensulfuron-methyl, thiobencarb, tiafenacil, tolpyralate, topramezone, tralkoxydim, triafamone, tri-allate, triasulfuron, triaziflam, tribenuron, tribenuron-methyl, triclopyr, trietazine, trifloxysulfuron, trifloxysulfuron-sodium, trifludimoxazin, trifluralin, triflusulfuron, triflusulfuron-methyl, tritosulfuron, urea sulfate, vernolate, ZJ-0862, i.e. 3,4-dichloro-N-{2-[(4,6-dimethoxypyrimidin-2-yl)oxy]benzyl}aniline.

Most preferred herbicides are acetochor, bromoxynil-ocatanoate-heptanoate, fenoxaprop-P-ethyl, glyphosate, iodosulfuron-methyl-sodium, indaziflam, mesosulfuron-methyl-sodium, tembotrione, thiencarbazone-methyl and triafamone.

Examples for plant growth regulators are:

Acibenzolar, acibenzolar-S-methyl, 5-aminolevulinic acid, ancymidol, 6-benzylaminopurine, Brassinolid, catechine, chlormequat chloride, cloprop, cyclanilide, 3-(cycloprop-1-enyl) propionic acid, daminozide, dazomet, n-decanol, dikegulac, dikegulac-sodium, endothal, endothal-dipotassium, -disodium, and -mono(N,N-dimethylalkylammonium), ethephon, flumetralin, flurenol, flurenol-butyl, flurprimidol, forchlorfenuron, gibberellic acid, inabenfide, indol-3-acetic acid (IAA), 4-indol-3-ylbutyric acid, isoprothiolane, probenazole, jasmonic acid, maleic hydrazide, mepiquat chloride, 1-methylcyclopropene, methyl jasmonate, 2-(1-naphthyl)acetamide, 1-naphthylacetic acid, 2-naphthyloxyacetic acid, nitrophenolate-mixture, paclobutrazol, N-(2-phenylethyl)-beta-alanine, N-phenylphthalamic acid, prohexadione, prohexadione-calcium, prohydrojasmone, salicylic acid, strigolactone, tecnazene, thidiazuron, triacontanol, trinexapac, trinexapac-ethyl, tsitodef, uniconazole, uniconazole-P.

Safeners:

S1) compounds of the group of heterocyclic carboxylic acid derivatives:

S1a) compounds of the type of dichlorophenylpyrazoline-3-carboxylic acid (S1a), preferably compounds such as 1-(2,4-dichlorophenyl)-5-(ethoxycarbonyl)-5-methyl-2-pyrazoline-3-carboxylic acid, ethyl 1-(2,4-dichlorophenyl)-5-(ethoxycarbonyl)-5-methyl-2-pyrazoline-3-carboxylate (S1-1) (“mefenpyr(-diethyl)”), and related compounds, as described in WO-A-91/07874;

S1b) derivatives of dichlorophenylpyrazolecarboxylic acid (S1b), preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4) and related compounds, as described in EP-A-333 131 and EP-A-269 806;

S1c) derivatives of 1,5-diphenylpyrazole-3-carboxylic acid (S1c), preferably compounds such as ethyl 1-(2,4-dichlorophenyl)-5-phenylpyrazole-3-carboxylate (S1-5), methyl 1-(2-chlorophenyl)-5-phenylpyrazole-3-carboxylate (S1-6) and related compounds, as described, for example, in EP-A-268554;

S1d) compounds of the type of triazolecarboxylic acids (S1d), preferably compounds such as fenchlorazole (-ethyl), i.e. ethyl 1-(2,4-dichlorophenyl)-5-trichloromethyl-(1H)-1,2,4-triazole-3-carboxylate (S1-7), and related compounds, as described in EP-A-174 562 and EP-A-346 620;

S1e) compounds of the type of 5-benzyl- or 5-phenyl-2-isoxazoline-3-carboxylic acid or 5,5-diphenyl-2-isoxazoline-3-carboxylic acid (S1e), preferably compounds such as ethyl 5-(2,4-dichlorobenzyl)-2-isoxazoline-3-carboxylate (S1-8) or ethyl 5-phenyl-2-isoxazoline-3-carboxylate (S1-9) and related compounds, as described in WO-A-91/08202, or 5,5-diphenyl-2-isoxazolinecarboxylic acid (S1-10) or ethyl 5,5-diphenyl-2-isoxazolinecarboxylate (S1-11) (“isoxadifen-ethyl”) or n-propyl 5,5-diphenyl-2-isoxazolinecarboxylate (S1-12) or ethyl 5-(4-fluorophenyl)-5-phenyl-2-isoxazoline-3-carboxylate (S1-13), as described in the patent application WO-A-95/07897.

S2) Compounds of the group of 8-quinolinoxy derivatives (S2):

S2a) compounds of the type of 8-quinolinoxyacetic acid (S2a), preferably 1-methylhexyl (5-chloro-8-quinolinoxy)acetate (common name “cloquintocet-mexyl” (S2-1), 1,3-dimethyl-but-1-yl (5-chloro-8-quinolinoxy)acetate (S2-2), 4-allyloxybutyl (5-chloro-8-quinolinoxy)acetate (S2-3), 1-allyloxyprop-2-yl (5-chloro-8-quinolinoxy)acetate (S2-4), ethyl (5-chloro-8-quinolinoxy)acetate (S2-5), methyl (5-chloro-8-quinolinoxy)acetate (S2-6), allyl (5-chloro-8-quinolinoxy)acetate (S2-7), 2-(2-propylideneiminoxy)-1-ethyl (5-chloro-8-quinolinoxy)acetate (S2-8), 2-oxo-prop-1-yl (5-chloro-8-quinolinoxy)acetate (S2-9) and related compounds, as described in EP-A-86 750, EP-A-94 349 and EP-A-191 736 or EP-A-0 492 366, and also (5-chloro-8-quinolinoxy)acetic acid (S2-10), its hydrates and salts, for example its lithium, sodium, potassium, calcium, magnesium, aluminium, iron, ammonium, quaternary ammonium, sulphonium or phosphonium salts, as described in WO-A-2002/34048;

S2b) compounds of the type of (5-chloro-8-quinolinoxy)malonic acid (S2b), preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.

S3) Active compounds of the type of dichloroacetamides (S3) which are frequently used as pre-emergence safeners (soil-acting safeners), such as, for example, “dichlormid” (N,N-diallyl-2,2-dichloroacetamide) (S3-1), “R-29148” (3-dichloroacetyl-2,2,5-trimethyl-1,3-oxazolidine) from Stauffer (S3-2),

“R-28725” (3-dichloroacetyl-2,2-dimethyl-1,3-oxazolidine) from Stauffer (S3-3), “benoxacor” (4-dichloroacetyl-3,4-dihydro-3-methyl-2H-1,4-benzoxazine) (S3-4), “PPG-1292” (N-allyl-N-[(1,3-dioxolan-2-yl)methyl]dichloroacetamide) from PPG Industries (S3 5), “DKA-24” (N-allyl-N-[(allylaminocarbonyl)methyl]dichloroacetamide) from Sagro-Chem (S3-6), “AD-67” or “MON 4660” (3-dichloroacetyl-1-oxa-3-aza-spiro[4,5]decane) from Nitrokemia or Monsanto (S3-7), “TI-35” (1-dichloroacetylazepane) from TRI-Chemical RT (S3-8) “diclonon” (dicyclonon) or “BAS145138” or “LAB145138” (S3-9) ((RS)-1-dichloroacetyl-3,3, 8a-trimethylperhydropyrrolo[1,2-a] pyrimidin-6-one) from BASF, furilazole” or “MON 13900” ((RS)-3-dichloroacetyl-5-(2-furyl)-2,2-dimethyloxazolidine) (S3-10), and also its (R)-isomer (S3-11).

S4) Compounds of the class of acylsulphonamides (S4):

S4a)N-acylsulphonamides of the formula (S4a) and salts thereof, as described in WO-A-97/45016 in which

RA1 is (C1-C6)-alkyl, (C3-C6)-cycloalkyl, where the 2 last-mentioned radicals are substituted by vA substituents from the group consisting of halogen, (C1-C4)-alkoxy, halo-(C1-C6)-alkoxy and (C1-C4)-alkylthio and, in the case of cyclic radicals, also (C1-C4)-alkyl and (C1-C4)-haloalkyl;

RA2 is halogen, (C1-C4)-alkyl, (C1-C4)-alkoxy, CF3;

mA is 1 or 2;

vD is 0, 1, 2 or 3;

S4b) compounds of the type of 4-(benzoylsulphamoyl)benzamides of the formula (S4b) and salts thereof, as described in WO-A-99/16744, in which

RB1, RB2 independently of one another are hydrogen, (C1-C6)-alkyl, (C3-C6)-cycloalkyl, (C3-C6)-alkenyl, (C3-C6)-alkynyl,

RB3 is halogen, (C1-C4)-alkyl, (C1-C4)-haloalkyl or (C1-C4)-alkoxy,

mB is 1 or 2;

for example those in which

RB1=cyclopropyl, RB2=hydrogen and (RB3)=2-OMe (“cyprosulfamide”, S4-1),

RB1=cyclopropyl, RB2=hydrogen and (RB3)=5-Cl-2-OMe (S4-2),

RB1=ethyl, RB2=hydrogen and (RB3)=2-OMe (S4-3),

RB1=isopropyl, RB2=hydrogen and (RB3)=5-Cl-2-OMe (S4-4) and

RB1=isopropyl, RB2=hydrogen and (RB3)=2-OMe (S4-5);

S4c) compounds of the class of benzoylsulphamoylphenylureas of the formula (S4c) as described in EP-A-365484,

in which

RC1, RC2 independently of one another are hydrogen, (C1-C8)-alkyl, (C3-C8)-cycloalkyl, (C3-C6)-alkenyl, (C3-C6)-alkynyl,

RC3 is halogen, (C1-C4)-alkyl, (C1-C4)-alkoxy, CF3,

mC is 1 or 2;

for example

1-[4-(N-2-methoxybenzoylsulphamoyl)phenyl]-3-methylurea (“metcamifen”, S4-6), 1-[4-(N-2-methoxybenzoylsulphamoyl)phenyl]-3,3-dimethylurea, 1-[4-(N-4,5-dimethylbenzoylsulphamoyl)phenyl]-3-methylurea;

S4d) compounds of the type of N-phenylsulphonylterephthalamides of the formula (S4d) and salts thereof, which are known, for example, from CN 101838227,

in which

RD4 is halogen, (C1-C4)-alkyl, (C1-C4)-alkoxy, CF3;

mD is 1 or 2;

RD5 is hydrogen, (C1-C6)-alkyl, (C3-C6)-cycloalkyl, (C2-C6)-alkenyl, (C2-C6)-alkynyl, (C5-C6)-cycloalkenyl.

S5) Active compounds from the class of hydroxyaromatics and aromatic-aliphatic carboxylic acid derivatives (S5), for example ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicyclic acid, 2-hydroxycinnamic acid, 2,4-dichlorocinnamic acid, as described in WO-A-2004/084631, WO-A-2005/015994, WO-A-2005/016001.

S6) Active compounds from the class of 1,2-dihydroquinoxalin-2-ones (S6), for example 1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulphonylaminoethyl)-3-(2-thienyl)-1,2-dihydroquinoxalin-2-one, as described in WO-A-2005/112630.

S7) Compounds from the class of diphenylmethoxyacetic acid derivatives (S7), for example methyl diphenylmethoxyacetate (CAS-Reg. Nr. 41858-19-9) (S7-1), ethyl diphenylmethoxyacetate, or diphenylmethoxyacetic acid, as described in WO-A-98/38856.

S8) Compounds of the formula (S8), as described in WO-A-98/27049, where the symbols and indices have the following meanings:

RD1 is halogen, (C1-C4)-alkyl, (C1-C4)-haloalkyl, (C1-C4)-alkoxy, (C1-C4)-haloalkoxy,

RD2 is hydrogen or (C1-C4)-alkyl,

RD3 is hydrogen, (C1-C8)-alkyl, (C2-C4)-alkenyl, (C2-C4)-alkynyl or aryl, where each of the carbon-containing radicals mentioned above is unsubstituted or substituted by one or more, preferably by up to three, identical or different radicals from the group consisting of halogen and alkoxy; or salts thereof,

nD is an integer from 0 to 2.

S9) Active compounds from the class of 3-(5-tetrazolylcarbonyl)-2-quinolones (S9), for example 1,2-dihydro-4-hydroxy-1-ethyl-3-(5-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No.: 95855-00-8), as described in WO-A-1999/000020.

S10) Compounds of the formula (S10a) or (S10b) as described in WO-A-2007/023719 and WO-A-2007/023764

in which RE1 is halogen, (C1-C4)-alkyl, methoxy, nitro, cyano, CF3, OCF3

YE, ZE independently of one another are O or S,

nE is an integer from 0 to 4,

RE2 is (C1-C16)-alkyl, (C2-C6)-alkenyl, (C3-C6)-cycloalkyl, aryl; benzyl, halobenzyl,

RE3 is hydrogen or (C1-C6)-alkyl.

S11) Active compounds of the type of oxyimino compounds (S11), which are known as seed dressings, such as, for example, “oxabetrinil” ((Z)-1,3-dioxolan-2-ylmethoxyimino(phenyl)acetonitrile) (S11-1), which is known as seed dressing safener for millet against metolachlor damage,

“fluxofenim” (1-(4-chlorophenyl)-2,2,2-trifluoro-1-ethanone O-(1,3-dioxolan-2-ylmethyl)oxime) (S11-2), which is known as seed dressing safener for millet against metolachlor damage, and

“cyometrinil” or “CGA-43089” ((Z)-cyanomethoxyimino(phenyl)acetonitrile) (S11-3), which is known as seed dressing safener for millet against metolachlor damage.

S12) Active compounds from the class of isothiochromanones (S12), such as, for example, methyl [(3-oxo-1H-2-benzothiopyran-4(3H)-ylidene)methoxy] acetate (CAS Reg. No.: 205121-04-6) (S12-1) and related compounds from WO-A-1998/13361.

S13) One or more compounds from group (S13):

“naphthalic anhydrid” (1,8-naphthalenedicarboxylic anhydride) (S13-1), which is known as seed dressing safener for corn against thiocarbamate herbicide damage,

“fenclorim” (4,6-dichloro-2-phenylpyrimidine) (S13-2), which is known as safener for pretilachlor in sown rice,

“flurazole” (benzyl 2-chloro-4-trifluoromethyl-1,3-thiazole-5-carboxylate) (S13-3), which is known as seed dressing safener for millet against alachlor and metolachlor damage,

“CL 304415” (CAS Reg. No.: 31541-57-8) (4-carboxy-3,4-dihydro-2H-1-benzopyran-4-acetic acid) (S13-4) from American Cyanamid, which is known as safener for corn against imidazolinone damage,

“MG 191” (CAS Reg. No.: 96420-72-3) (2-dichloromethyl-2-methyl-1,3-dioxolane) (S13-5) from Nitrokemia, which is known as safener for corn,

“MG 838” (CAS Reg. No.: 133993-74-5) (2-propenyl 1-oxa-4-azaspiro [4 0.5] decane-4-carbodithioate) (S13-6) from Nitrokemia,

“disulphoton” (O,O-diethyl S-2-ethylthioethyl phosphorodithioate) (S13-7),

“dietholate” (O,O-diethyl O-phenyl phosphorothioate) (S13-8),

“mephenate” (4-chlorophenyl methylcarbamate) (S13-9).

S14) Active compounds which, besides a herbicidal effect against harmful plants, also have a safener effect on crop plants such as rice, such as, for example, “dimepiperate” or “MY 93” (S-1-methyl-1-phenylethyl piperidine-1-carbothioate), which is known as safener for rice against molinate herbicide damage,

“daimuron” or “SK 23” (1-(1-methyl-1-phenylethyl)-3-p-tolylurea), which is known as safener for rice against imazosulphuron herbicide damage,

“cumyluron”=“JC 940” (3-(2-chlorophenylmethyl)-1-(1-methyl-1-phenylethyl)urea, see JP-A-60087254), which is known as safener for rice against some herbicide damage,

“methoxyphenone” or “NK 049” (3,3′-dimethyl-4-methoxybenzophenone), which is known as safener for rice against some herbicide damage,

“CSB” (1-bromo-4-(chloromethylsulphonyl)benzene) from Kumiai (CAS Reg. No. 54091-06-4), which is known as safener against some herbicide damage in rice.

S15) Compounds of the formula (S15) or its tautomers,

as described in WO-A-2008/131861 and WO-A-2008/131860,

in which

RH1 is (C1-C6)-haloalkyl,

RH2 is hydrogen or halogen,

RH3, RH4 independently of one another are hydrogen, (C1-C16)-alkyl, (C2-C16)-alkenyl or (C2-C16)-alkynyl,

where each of the 3 last-mentioned radicals is unsubstituted or substituted by one or more radicals from the group consisting of halogen, hydroxy, cyano, (C1-C4)-alkoxy, (C1-C4)-haloalkoxy, (C1-C4)-alkylthio, (C1-C4)-alkylamino, di-[(C1-C4)-alkyl]-amino, [(C1-C4)-alkoxy]-carbonyl, RC1-C4)-haloalkoxyl-carbonyl, unsubstituted or substituted (C3-C6)-cycloalkyl, unsubstituted or substituted phenyl, and unsubstituted or substituted heterocyclyl;

or (C3-C6)-cycloalkyl, (C4-C6)-cycloalkenyl, (C3-C6)-cycloalkyl which is at one site of the ring condensed with a 4 to 6-membered saturated or unsaturated carbocyclic ring, or (C4-C6)-cycloalkenyl which is at one site of the ring condensed with a 4 to 6-membered saturated or unsaturated carbocyclic ring,

where each of the 4 last-mentioned radicals is unsubstituted or substituted by one or more radicals from the group consisting of halogen, hydroxy, cyano, (C1-C4)-alkyl, (C1-C4)-haloalkyl, (C1-C4)-alkoxy, (C1-C4)-haloalkoxy, (C1-C4)-alkylthio, (C1-C4)-alkylamino, di-(C1-C4)-alkyl]-amino, RC1-C4)-alkoxyl-carbonyl, RC1-C4)-haloalkoxyl-carbonyl, unsubstituted or substituted (C3-C6)-cycloalkyl, unsubstituted or substituted phenyl, and unsubstituted or substituted heterocyclyl; or

RH3 is (C1-C4)-alkoxy, (C2-C4)-alkenyloxy, (C2-C6)-alkynyloxy or (C2-C4)-haloalkoxy, and

RH4 is hydrogen or (C1-C4)-alkyl, or

RH3 and RH4 together with the directly bound N-atom are a 4 to 8-membered heterocyclic ring, which can contain further hetero ring atoms besides the N-atom, preferably up to two further hetero ring atoms from the group consisting of N, O and S, and which is unsubstituted or substituted by one or more radicals from the group consisting of halogen, cyano, nitro, (C1-C4)-alkyl, (C1-C4)-haloalkyl, (C1-C4)-alkoxy, (C1-C4)-haloalkoxy, and (C1-C4)-alkylthio.

S16) Active compounds which are primarily used as herbicides, but also have safener effect on crop plants, for example

(2,4-dichlorophenoxy)acetic acid (2,4-D), (4-chlorophenoxy)acetic acid, (R,S)-2-(4-chloro-o-tolyloxy)propionic acid (mecoprop), 4-(2,4-dichlorophenoxy)butyric acid (2,4-DB), (4-chloro-o-tolyloxy)acetic acid (MCPA), 4-(4-chloro-o-tolyloxy)butyric acid, 4-(4-chlorophenoxy)butyric acid, 3,6-dichloro-2-methoxybenzoic acid (dicamba), 1-(ethoxycarbonyl)ethyl 3,6-dichloro-2-methoxybenzoate (lactidichlor-ethyl).

Preferred safeners are cloquintocet-mexyl, cyprosulfamid, fenchlorazole-ethyl, isoxadifen-ethyl, mefenpyr-diethyl, fenclorim, cumyluron, S4-1, S4-5 and metcamifen, particular preference is given to: cloquintocet-mexyl, cyprosulfamid, isoxadifen-ethyl, mefenpyr-diethyl and metcamifen.

Most preferred safeners are isoxadifen-ethyl, mefenpyr-diethyl.

Organosilicone-Based Surfactants (b) are—Add List

Suitable organosilicone ethoxylates are organomodified polysiloxanes/trisiloxane alkoxylates with the following CAS No. 27306-78-1, 67674-67-3, 134180-76-0, e.g., Silwet® L77, Silwet® 408, Silwet® 806, BreakThru® S240, BreakThru® S278;

Preferred are polyalkyleneoxide modified heptamethyltrisiloxane, preferably selected from the group comprising the siloxane groups Poly(oxy-1,2-ethanediyl), .alpha.-methyl-.omega.-[3-[1,3,3,3-tetramethyl-1-[(trimethylsilyl)oxy] disiloxanyl]propoxy] (CAS No (27306-78-1), Poly(oxy-1,2-ethanediyl), .alpha.-[3-[1,3,3,3-tetramethyl-1-[(trimethylsilyl)oxy] disiloxanyl]propyl]-.omega.-hydroxy (Cas No 67674-67-3), and Oxirane, methyl-, polymer with oxirane, mono3-1,3,3,3-tetramethyl-1-(trimethylsilyl)oxydisiloxanylpropyl ether (Cas No 134180-76-0).

Other Formulants (c) are:

C1 Suitable non-ionic surfactants c1) are all substances of this type which can customarily be employed in agrochemical agents. Preferably, polyethylene oxide-polypropylene oxide block copolymers, preferably having a molecular weight of more than 6,000 g/mol or a polyethylene oxide content of more than 45%, more preferably having a molecular weight of more than 6,000 g/mol and a polyethylene oxide content of more than 45%, polyethylene glycol ethers of branched or linear alcohols, reaction products of fatty acids or fatty acid alcohols with ethylene oxide and/or propylene oxide, furthermore polyvinyl alcohol, polyoxyalkylenamine derivatives, polyvinylpyrrolidone, copolymers of polyvinyl alcohol and polyvinylpyrrolidone, and copolymers of (meth)acrylic acid and (meth)acrylic acid esters, furthermore branched or linear alkyl ethoxylates and alkylaryl ethoxylates, where polyethylene oxide-sorbitan fatty acid esters may be mentioned by way of example. Out of the examples mentioned above selected classes can be optionally phosphated, sulphonated or sulphated and neutralized with bases.

Possible anionic surfactants c3) are all substances of this type which can customarily be employed in agrochemical agents. Alkali metal, alkaline earth metal and ammonium salts of alkylsulphonic or alkylphospohric acids as well as alkylarylsulphonic or alkylarylphosphoric acids are preferred. A further preferred group of anionic surfactants or dispersing aids are alkali metal, alkaline earth metal and ammonium salts of polystyrenesulphonic acids, salts of polyvinylsulphonic acids, salts of alkylnaphthalene sulphonic acids, salts of naphthalene-sulphonic acid-formaldehyde condensation products, salts of condensation products of naphthalenesulphonic acid, phenolsulphonic acid and formaldehyde, and salts of lignosulphonic acid. Mono- and diesters of sulfosuccinate metal salts with branched or linear alcohols comprising 1-10 carbon atoms, in particular alkali metal salts, more particular sodium salts, and most particular sodium dioctylsulfosuccinate.

c2 A rheological modifier is an additive that when added to the recipe at a concentration that reduces the gravitational separation of the dispersed active ingredient during storage results in a substantial increase in the viscosity at low shear rates. Low shear rates are defined as 0.1 s⁻¹ and below and a substantial increase as greater than ×2 for the purpose of this invention. The viscosity can be measured by a rotational shear rheometer.

Suitable rheological modifiers c2) by way of example are:
Polysaccharides including xanthan gum, guar gum and hydroxyethyl cellulose. Examples are Kelzan®, Rhodopol® G and 23, Satiaxane® CX911 and Natrosol® 250 range.
Clays including montmorillonite, bentonite, sepeolite, attapulgite, laponite, hectorite. Examples are Veegum® R, Van Gel® B, Bentone® CT, HC, EW, Pangel® M100, M200, M300, S, M, W, Attagel® 50, Laponite® RD,
Fumed and precipitated silica, examples are Aerosil® 200, Sipernat® 22.

Preferred are xanthan gum, montmorillonite clays, bentonite clays and fumed silica.

c3 Suitable antifoam substances c3) are all substances which can customarily be employed in agrochemical agents for this purpose. Silicone oils, silicone oil preparations are preferred. Examples are Silcolapse® 426 and 432 from Bluestar Silicones, Silfoam® SRE and SC132 from Wacker, SAF-184® from Silchem, Foam-Clear ArraPro-S® from Basildon Chemical Company Ltd, SAG® 1572 and SAG® 30 from Momentive [Dimethyl siloxanes and silicones, CAS No. 63148-62-9]. Preferred is SAG® 1572.

c4 Suitable other formulants c4) are selected from biocides, antifreeze, colourants, pH adjusters, buffers, stabilisers, antioxidants, inert filling materials, humectants, crystal growth inhibitors, micronutrients by way of example are:

Possible preservatives are all substances which can customarily be employed in agrochemical agents for this purpose. Suitable examples for preservatives are preparations containing 5-chloro-2-methyl-4-isothiazolin-3-one [CAS-No. 26172-55-4], 2-methyl-4-isothiazolin-3-one [CAS-No. 2682-20-4] or 1.2-benzisothiazol-3(2H)-one [CAS-No. 2634-33-5]. Examples which may be mentioned are Preventol® D7 (Lanxess), Kathon® CG/ICP (Dow), Acticide® SPX (Thor GmbH) and Proxel® GXL (Arch Chemicals).

Suitable antifreeze substances are all substances which can customarily be employed in agrochemical agents for this purpose. Suitable examples are propylene glycol, ethylene glycol, urea and glycerine.

Possible colourants are all substances which can customarily be employed in agrochemical agents for this purpose. Titanium dioxide, carbon black, zinc oxide, blue pigments, Brilliant Blue FCF, red pigments and Permanent Red FGR may be mentioned by way of example.

Possible pH adjusters and buffers are all substances which can customarily be employed in agrochemical agents for this purpose. Citric acid, sulfuric acid, hydrochloric acid, sodium hydroxide, sodium hydrogen phosphate (Na₂HPO₄), sodium dihydrogen phosphate (NaH₂PO₄), potassium dihydrogen phosphate (KH₂PO₄), potassium hydrogen phosphate (K₂HPO₄), may be mentioned by way of example.

Suitable stabilisers and antioxidants are all substances which can customarily be employed in agrochemical agents for this purpose. Butylhydroxytoluene [3.5-Di-tert-butyl-4-hydroxytoluol, CAS-No. 128-37-0] is preferred.

Carriers (d) are those which can customarily be used for this purpose in agrochemical formulations.

A carrier is a solid or liquid, natural or synthetic, organic or inorganic substance that is generally inert, and which may function as a solvent. The carrier generally improves the application of the compounds, for instance, to plants, plants parts or seeds. Examples of suitable

solid carriers include, but are not limited to, ammonium salts, in particular ammonium sulfates, ammonium phosphates and ammonium nitrates, natural rock flours, such as kaolins, clays, talc, chalk, quartz, attapulgite, montmorillonite and diatomaceous earth, silica gel and synthetic rock flours, such as finely divided silica, alumina and silicates. Examples of typically useful solid carriers for preparing granules include but are not limited to crushed and fractionated natural rocks such as calcite, marble, pumice, sepiolite and dolomite, synthetic granules of inorganic and organic flours and granules of organic material such as paper, sawdust, coconut shells, maize cobs and tobacco stalks.

Preferred solid carriers are selected from clays, talc and silica.

Examples of suitable liquid carriers include, but are not limited to, water, organic solvents and combinations thereof. Examples of suitable solvents include polar and nonpolar organic chemical liquids, for example from the classes of
aromatic and nonaromatic hydrocarbons (such as cyclohexane, paraffins, alkylbenzenes, xylene, toluene, tetrahydronaphthalene, alkylnaphthalenes, chlorinated aromatics or chlorinated aliphatic hydrocarbons such as chlorobenzenes, chloroethylenes or methylene chloride),
alcohols and polyols (which may optionally also be substituted, etherified and/or esterified, such as ethanol, propanol, butanol, benzylalcohol, cyclohexanol or glycol, 2-ethyl hexanol),
ethers such as dioctyl ether, tetrahydrofuran, dimethyl isosorbide, solketal, cyclopentyl methyl ether, solvents offered by Dow under the Dowanol Product Range e.g. Dowanol DPM, anisole, phenetole, different molecular weight grades of dimethyl polyethylene glycol, different molecular weight grades of dimethyl polypropylene glycol, dibenzyl ether
ketones (such as acetone, methyl ethyl ketone, methyl isobutyl ketone, cyclopentanone, cyclohexanone, cycloheptanone, acetophenone, propiophenone),
esters (also including methylated fats and oils such as rapeseed oil methyl ester, soybean oil methyl ester, coconut oil methyl ester, 2-ethyl hexyl palmitate, 2-ethyl hexyl stearate), such as butyl propionate, pentyl propionate, methyl hexanoate, methyl octanoate, methyl decanoate, 2-ethyl-hexyl acetate, benzyl acetate, cyclohexyl acetate, isobornyl acetate, benzyl benzoate, butyl benzoate, isopropyl benzoate, dimethyl succinate, dimethyl glutarate, dimethyl adipate, diisopropyl adipate, dibutyl adipate, Benzyl-2-ethylhexyl adipate, dimethyl 2-methyl glutarate, monoacetin, diacetin, triacetin, trimethyl citrate, triethyl citrate, triethyl acetyl citrate, tributyl citrate, tributyl acetyl citrate
lactate esters, such as methyl lactate, ethyl lactate, propyl lactate, butyl lactate, 2-ethyl hexyl lactate
(poly)ethers such as different molecular weight grades of polyethylene glycol, different molecular weight grades of polypropylene glycol
unsubstituted and substituted amines
amides (such as dimethylformamide, or N,N-dimethyl lactamide, or N-formyl morpholine, or fatty acid amides such N,N-dimethyl decanamide or N,N-dimethyl dec-9-en-amide) and esters thereof
lactams (such as 2-pyrrolidone, or N-alkylpyrrolidones, such as N-methylpyrrolidone, or N-butylpyrrolidone, or N-octylpyrrolidone, or N-dodecylpyrrolidone or N-methyl caprolactam, N-alkyl caprolactam)
lactones (such as gamma-butyrolactone, gamma-valerolactone, delta-valerolactone, or alpha-methyl gamma-butyrolactone
sulfones and sulfoxides (such as dimethyl sulfoxide),
oils of vegetable or animal origin such as sunflower oil, rapeseed oil, corn oil
nitriles, such as linear or cyclic alkyl nitriles, in particular acetonitrile, cyclohexane carbonitrile, octanonitrile, dodecanonitrile).
linear and cyclic carbonates, such as diethyl carbonate, dipropyl carbonate, dibutyl carbonate, dioctyl carbonate, or ethylene carbonate, propylene carbonate, butylene carbonate, glycerine carbonate
phosphates, such as triethyl phosphate, tributyl phosphate, triisobutyl phosphate, trioctyl phosphate, tris(2-ethyl hexyl) phosphate
white mineral oils
Mixtures of the above like RPDE, FMPC A128 1221 “crodamol OP cegesoft 24” CETIOL® 868, Match 111, Rhodiasol green/25, Miglyol 812N, Agnique ME 610, Agnique ME 890

As liquid carrier water is most preferred in one embodiment, preferably if the formulation is an SC.

In case of an OD or EC mineral oils are preferred as carrier.

In case of a WG natural rock flours are preferred as carrier.

These spray liquids are applied by customary methods, i.e., for example, by spraying, pouring or injecting, in particular by spraying, and most particular by spraying by UAV.

The application rate of the formulations according to the invention can be varied within a relatively wide range. It is guided by the particular active agrochemicals and by their amount in the formulations.

With the aid of the formulations according to the invention it is possible to deliver active agrochemical to plants and/or their habitat in a particularly advantageous way.

The present invention is also directed to the use of agrochemical compositions according to the invention for the application of the agrochemical active compounds contained to plants and/or their habitat.

With the formulations of the invention it is possible to treat all plants and plant parts. By plants here are meant all plants and plant populations, such as desirable and unwanted wild plants, weeds or crop plants (including naturally occurring crop plants). Crop plants may be plants which can be obtained by conventional breeding and optimization methods or by biotechnological and gene-technological methods or combinations of these methods, including the transgenic plants and including the plant cultivars which can or cannot be protected by varietal property rights. By plant parts are to be meant all above-ground and below-ground parts and organs of the plants, such as shoot, leaf, flower and root, an exemplary listing embracing leaves, needles, stems, trunks, flowers, fruit bodies, fruits and seeds and also roots, tubers and rhizomes. The plant parts also include harvested material and also vegetative and generative propagation material.

What may be emphasized in this context is the particularly advantageous effect of the formulations according to the invention with regard to their use in cereal plants such as, for example, wheat, oats, barley, spelt, triticale and rye, but also in maize, sorghum and millet, rice, sugar cane, soya beans, sunflowers, potatoes, cotton, oilseed rape, canola, tobacco, sugar beet, fodder beet, asparagus, hops and fruit plants (comprising pome fruit such as, for example, apples and pears, stone fruit such as, for example, peaches, nectarines, cherries, plums and apricots, citrus fruits such as, for example, oranges, grapefruits, limes, lemons, kumquats, tangerines and satsumas, nuts such as, for example, pistachios, almonds, walnuts and pecan nuts, tropical fruits such as, for example, mango, papaya, pineapple, dates and bananas, and grapes) and vegetables (comprising leaf vegetables such as, for example, endives, corn salad, Florence fennel, lettuce, cos lettuce, Swiss chard, spinach and chicory for salad use, cabbages such as, for example, cauliflower, broccoli, Chinese leaves, Brassica oleracea (L.) convar. acephala var. sabellica L. (curly kale, feathered cabbage), kohlrabi, Brussels sprouts, red cabbage, white cabbage and Savoy cabbage, fruit vegetables such as, for example, aubergines, cucumbers, capsicums, table pumpkins, tomatoes, courgettes and sweetcorn, root vegetables such as, for example celeriac, wild turnips, carrots, including yellow cultivars, Raphanus sativus var. niger and var. radicula, beetroot, scorzonera and celery, legumes such as, for example, peas and beans, and vegetables from the Allium family such as, for example, leeks and onions.

The treatment of the plants and plant parts in accordance with the invention with the inventive formulations is carried out directly or by action on their environment, habitat or storage area in accordance with the customary treatment methods, for example by dipping, spraying, vaporizing, atomizing, broadcasting or painting on and, in the case of propagation material, especially seeds, additionally by single or multiple coating.

The active agrochemicals comprised develop a better biological activity than when applied in the form of the corresponding conventional formulations.

Leaf Surfaces

In Tables 1a and 1b the contact angle of water on leaf surfaces for textured and non-textured is shown.

TABLE 1a
Plants with textured leaves

| | | Contact angle of |
|---|---|---|
| Plant | Species | water ° (adaxial) |
| barley | Hordeum vulgare | 143° |
| | (var. Montoya) | |
| corn, BBCH-11 | Zea mays | 150° |
| corn, BBCH-12 | Zea mays | 149° |
| corn, BBCH-13/14 | Zea mays | 148° |
| soybean, BBCH-12 | Glycine max | 149° |
| soybean, BBCH-13 | Glycine max | 144° |
| rice | Oryza sativa | 180° |
| wheat, BBCH-12 | Triticum aestivum | 148° |
| fat-hen | Chenopodium album | 137° |
| purple crabgrass | Digitaria sanguinalis | 144° |

TABLE 1b
Plants with non-textured leaves

| | | Contact angle of |
|---|---|---|
| Plant | Species | water ° (adaxial) |
| apple | Malus domestica | 104° |
| tomato | Solanum lycopersicum | 106° |
| corn, BBCH-15/16 | Zea mays | 108° |
| corn, BBCH-17 | Zea mays | 107° |
| corn, BBCH-18 | Zea mays | 96° |
| corn, BBCH-19 | Zea mays | 87° |
| velvetleaf | Abutilon theophrasti | 103° |
| redroot pigweed | Amaranthus retroflexus | not measured |

Examples of non-textured crops and plants include tomatoes, peppers, potatoes, carrot, celery, sugar beet, beetroot, spinach, lettuce, beans, peas, clover, apple, pear, peach, apricot, plum, mango, avocado, olive, citrus, orange, lemon, lime, grape, fig, cucumber, melon, water melon, strawberry, raspberry, blueberry, sunflower, pumpkin, soybean (>BBCH XX), corn (>BBCH15), cotton.

Examples of textured crops and plants include garlic, onions, leeks, soybean (<BBCH-XX), oats, wheat, barley, rice, sugarcane, pineapple, banana, linseed, lilies, orchids, corn (<BBCH15), cabbage, brussels sprouts, broccoli, Cauliflower, rye, rapeseed, tulips and peanut.

Examples of non-textured weeds include Abutilon theophrasti, Capsella bursa pastoris, Datura stramonium, Galium aparine, Ipomoea purpurea, Polygonum lapathifolium, Portulaca oleracea, Senecio vulgaris, Sida spinosa, Sinapis arvensis, Solanum nigrum, Stellaria media, Xanthium orientale, Cyperus rotundus, and Amaranthus retroflexus.

Examples of textured weeds include Cassia obtusifolia, Chenopodium album, Agropyron repens, Alopecurus myosuroides, Apera spica-venti, Avena fatua, Brachiaria plantaginea, Bromus secalinus, Cynodon dactylon, Digitaria sanguinalis, Echinochloa crus-galli, Panicum dichotomiflorum, Poa annua, Setaria faberi and Sorghum halepense.

### FIGURES

FIG. 1 shows scanning electron micrographs of leaf surface textures, wherein the upper picture shows a grapevine leaf surface (untextured) and the lower picture shows a soybean leaf surface (textured)

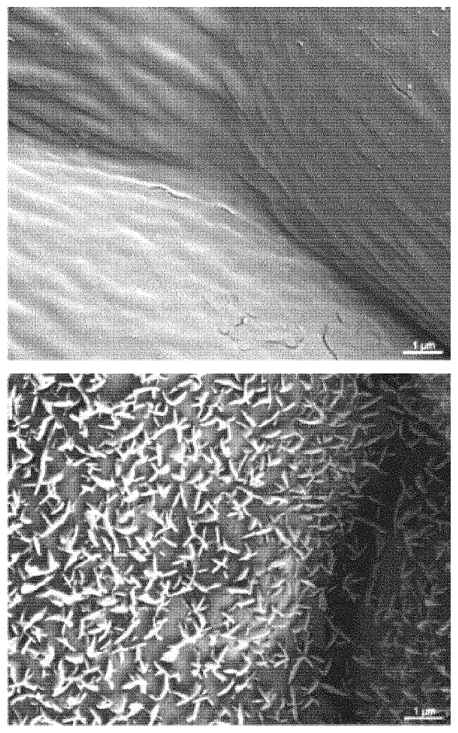

Since soy and corn change leaf properties over their lifetime, according to the present invention the treatment in regard to leaf properties can be adapted, i.e. the formulations according to the invention can be applied in a growth stadium where the leafs are hard to wet.

Method 1: SC Preparation

The method of the preparation of suspension concentrate formulations are known in the art and can be produced by known methods familiar to those skilled in the art. A 2% gel of the xanthan (c) in water and the biocides (c) was prepared with low shear stirring. The active ingredient and safener (a), non-ionic and anionic dispersants (c), antifoam (c) and other formulants (c) were mixed with water (d) to form a slurry, first mixed with a high shear rotor-stator mixer (Ultra-Turrax®) to reduce the particle size D(v,0.9) to approximately 50 microns, then passed through one or more bead mills (Eiger® 250 Mini Motormill) to achieve a particles size D(v,0.9) typically 1 to 15 microns. Then the superspreading surfactants (b) and xanthan gel prepared above were added and mixed in with low shear stirring until homogeneous. Finally, the pH is adjusted if needed with acid or base (c).

Method 2: WG Preparation

The methods of the preparation water dispersible granule formulations are known in the art and can be produced by known methods familiar to those skilled in the art.

For example, to produce a fluid bed granule first a water-based technical concentrate has to be prepared. With low shear stirring all ingredients (a, b, c and d) like e.g. the active ingredient, surfactants, dispersants, binder, antifoam, spreader, and filler are mixed in water and finally pre-milled in a high shear rotor-stator mixer (Ultra-Turrax®) to reduce the particle size D(v,0.9) to approximately 50 microns, afterwards passed through one or more bead mills (KDL, Bachofen, Dynomill, Bühler, Drais, Lehmann) to achieve a particles size D(v,0.9) typically 1 to 15 microns. This water-based technical concentrate is then spray-dried in a fluid-bed granulation process to form the wettable granules (WG).

The particle size is determined according to CIPAC (CIPAC=Collaborative International Pesticides Analytical Council; www.cipac.org) method MT 187. The particle size distribution is determined by means of laser diffraction. A representative amount of sample is dispersed in degassed water at ambient temperature (self-saturation of the sample), treated with ultrasound (usually 60 s) and then measured in a device from the Malvern Mastersizer series (Malvern Panalytical). The scattered light is measured at various angles using a multi-element detector and the associated numerical values are recorded. With the help of the Fraunhofer model, the proportion of certain size classes is calculated from the scatter data and from this a volume-weighted particle size distribution is calculated. Usually the d50 or d90 value=active ingredient particle size (50 or 90% of all volume particles) is given. The average particle size denotes the d50 value.

Likewise, any other spraying process, like e.g. classical spray drying can be used as granulation method.

A further technique to produce water dispersible granules is for example low pressure extrusion. The ingredients of the formulation are mixed in dry from and are subsequently milled, e.g. using air jet milling to reduce the particle size. Subsequently this dry powder is stirred while water is added to the mixture (approximately 10-30 wt %, dependent on the composition of the formulation). In a further step the mixture is pushed through an extruder (like a dome extruder, double dome extruder, basket extruder, sieve mill, or similar device) with a die size of usually between 0.8 and 1.2 mm to form the extrudates. In a last step the extrudates are post-dried, e.g. in a fluidized bed dryer to reduce the water content of the powder, commonly to a level of 1-3 wt % of residual water.

Method 3: EC Preparation

The method of the preparation of EC formulations are known in the art and can be produced by known methods familiar to those skilled in the art. In general, EC formulations are obtained by mixing the active ingredient and safener (a) with the rest of the formulation components, which include, amongst others, surfactants (c), superspreading surfactants (b), a solvent (d) in a vessel equipped with a stirring device. In some cases the dissolving or mixing was facilitated by raising the temperature slightly (not exceeding 60° C.). Stirring is continued until a homogeneous mixture has been obtained.

Method 4: OD Preparation

Formulation components (c), carrier (d) active ingredient (a), superspreading surfactants (b) are weighed in, homogenized with a high-shear device (e.g. Ultraturrax or colloidal mill) and subsequently milled in a bead mill (e.g. Dispermat SL50, 80% filling, 1.0-1.25 mm glass beads, 4000 rpm, circulation grinding) until a particle size of <10μ is achieved. Alternatively, formulation components are mixed in a bottle followed by addition of approx. 25 vol.-% of 1.0-1.25 mm glass beads. The bottle is then closed, clamped in an agitator apparatus (e.g. Retsch MM301) and treated at 30 Hz for several minutes until a particle size of <10μ is achieved.

Method 5: SL Preparation

The method of the preparation of EC formulations are known in the art and can be produced by known methods familiar to those skilled in the art. In general, EC formulations are obtained by mixing the active ingredient (a), surfactants and other formulants (c), spreader (b) in water (d) in a standard apparatus. In some cases the dissolving or mixing was facilitated by raising the temperature slightly (not exceeding 60° C.).

Method 6: Coverage

Greenhouse plants in the development stage as indicated in the Tables 1a & 1b were used for these experiments. Single leaves were cut just before the spraying experiment, placed into petri dishes and attached by tape at both tips at 0° (horizontally) or at 60° (so that 50% of leaf area can be sprayed). The leaves were carried with caution to avoid damage of the wax surface. These horizontally orientated leaves were either a) placed into a spay chamber where the spray liquid was applied via a hydraulic nozzle or b) a 4 μL drop of spray liquid was pipetted on top without touching the leaf surface.

A small amount of UV dye was added to the spray liquid to visualize the spray deposits under UV light. The concentration of the dye has been chosen such that it does not influence the surface properties of the spray liquid and does not contribute to spreading itself. Tinopal OB as a colloidal suspension was used for all flowable and solid formulation such as WG, SC, OD and SE. Tinopal CBS-X or Blankophor SOL were used for formulations where active ingredient is dissolved such as EC, EW and SL. The Tinopal CBS-X was dissolved in the aqueous phase and the Blankophor SOL dissolved in the oil phase.

After evaporation of the spray liquid, the leaves were placed into a Camag, Reprostar 3 UV chamber where pictures of spray deposits were taken under visual light and under UV light at 366 nm. A Canon EOS 700D digital camera was attached to the UV chamber and used to acquire images the leaves. Pictures taken under visual light were used to subtract the leaf shape from the background. ImageJ software was used to calculate either a) the percentage coverage of the applied spray for sprayed leaves or b) spread area for pipetted drops in mm².

Method 7: Description for Herbicide Greenhouse Tests

Seeds of crops and monocotyledonous and dicotyledonous harmful plants are laid out in sandy loam in plastic pots, covered with soil and cultivated in a greenhouse under optimum growth conditions. Two to three weeks after sowing, the test plants are treated at the one- to two-leaf stage. The test herbicide formulations are prepared with different concentrations and sprayed onto the surface of the green parts of the plants using different water application rates: 200 I/ha as a standard conventional rate and 10 l/ha as an ultra-low-volume (ULV) application rate. The nozzle type used for all applications is TeeJet DG 95015 EVS. The ULV application rate is achieved by using a pulse-width-modulation (PWM)—system that gets attached to the nozzle and the track sprayer device. After application, the test plants were left to stand in the greenhouse for 3 to 4 weeks under optimum growth conditions. Then, the activity of the herbicide formulation is scored visually (for example: 100% activity=the whole plant material is dead, 0% activity=plants are similar to the non-treated control plants).

TABLE HB1
shows the plant species used in the tests.

| Plant species | Abbreviation/EPPO Code | Crop Variety |
|---|---|---|
| Setaria viridis | SETVI | |
| Echinochloa crus-galli | ECHCG | |
| Alopecurus myosuroides | ALOMY | |
| Hordeum murinum | HORMU | |
| Avena fatua | AVEFA | |
| Lolium rigidum | LOLRI | |
| Matricaria inodora | MATIN | |
| Veronica persica | VERPE | |
| Abutilon theophrasti | ABUTH | |
| Pharbitis purpurea | PHBPU | |
| Polygonum convolvulus | POLCO | |
| Amaranthus retroflexus | AMARE | |
| Stellaria media | STEME | |
| Zea mays | ZEAMA | Aventura |
| Triticum aestivum | TRZAS | Triso |
| Brassica napus | BRSNW | Fontan |

TABLE HB2
shows the diseases and crops used in the tests.

| | | | | Abbreviation/ |
|---|---|---|---|---|
| Plant | Crop | | English | EPPO Code |
| species | Variety | Disease | Name | disease |
| Soybean | Merlin | Phakopsora | Soybean rust | PHAKPA |
| | | pachyrhizi | | |
| Wheat | Monopol | Puccinia triticina | Brown rust | PUCCRT |
| Barley | Gaulois | Pyrenophora teres | Net blotch | PYRNTE |
| Barley | Villa | Blumeria graminis | Powdery | ERYSGH |
| | | | mildew | |
| Tomato | Rentita | Phytophtora | Late blight | PHYTIN |
| | | infestans | | |

Materials

TABLE HB3
Exemplified trade names and CAS-No's of preferred organosilicone compounds (b)

| | | | Molecular | |
|---|---|---|---|---|
| Product | Chemical name | Cas No. | formula | Supplier |
| Silwet ® L77 | 3-(2-methoxyethoxy)propyl-methyl- | 27306-78-1 | C13H34O4Si3 | Momentive |
| | bis(trimethylsilyloxy)silane | | | |
| Silwet ® 408 | 2-[3- | 67674-67-3 | C14H38O5Si4 | Momentive |
| | [[dimethyl(trimethylsilyloxy)silyl]oxy- | | | |
| | methyl- | | | |
| | trimethylsilyloxysilyl]propoxy]ethanol | | | |
| Silwet ® 806 | 3-[methyl- | 134180-76-0 | C15H38O5Si3 | Momentive |
| | bis(trimethylsilyloxy)silyl]propan-1- | | | |
| | ol;2-methyloxirane;oxirane | | | |
| Break-thru ® | 3-[methyl- | 134180-76-0 | C15H38O5Si3 | Evonik |
| S240 | bis(trimethylsilyloxy)silyl]propan-1- | | | |
| | ol;2-methyloxirane;oxirane | | | |
| Break-thru ® | 3-(2-methoxyethoxy)propyl-methyl- | 27306-78-1 | C13H34O4Si3 | Evonik |
| S278 | bis(trimethylsilyloxy)silane | | | |
| Silwet ® HS | Polyalkylenoxid Silan | secret | — | Momentive |
| 312 | | | | |
| Silwet ® HS | Polyalkylenoxid Silan | 166736-08-9 | — | Momentive |
| 604 | | | | |
| BreakThru ® | Siloxanes and Silicones, cetyl Me, di- | 191044-49-2 | — | Evonik |
| OE 444 | Me | | | |

TABLE HB4
Exemplified trade names and CAS-No's of preferred compounds (c)

| | | | Molecular | |
|---|---|---|---|---|
| Product | Chemical name | Cas No. | formula | Supplier |
| Morwet ® D425 | Naphthalene sulphonate formaldehyde | 9008-63-3 | | Nouryon |
| | condensate Na salt | | | |
| Synperonic ® | block-copolymer of polyethylene | 9003-11-6 | | Croda |
| PE/F127 | oxide and polypropylene oxide | | | |
| Synperonic ® A7 | alcohol ethoxylate (C12/C15-EO7) | 68131-39-5 | | Croda |
| Xanthan | Polysaccharide | 11138-66-2 | | |
| Proxel ® GXL | 1.2-benzisothiazol-3(2H)-one | 2634-33-5 | | Arch |
| | | | | Chemicals |
| Kathon ® | 5-chloro-2-methyl-4-isothiazolin-3- | 26172-55-4 | | Dow |
| CG/ICP | one plus 2-methyl-4-isothiazolin-3- | plus | | |
| | one | 2682-20-4 | | |
| Propylene | 1,2-Propylene glycol | 57-55-6 | | |
| glycol | | | | |
| SAG ® 1572 | Dimethyl siloxanes and silicones | 63148-62-9 | | Momentive |
| Atlox ® 4913 | methyl methacrylate graft copolymer | 119724-54-8 | | Croda |
| | with polyethylene glycol | | | |
| Atlox 4894 | Ethoxylated C12-C15 fatty alcohol | 308061-37-2 | | Croda |
| | (15-30%) + EO-PO Block copolymer | | | |
| | n-butyl (40-60%) | | | |
| ATLAS ® G | Oxirane, methyl-, polymer with | 9038-95-3 | | Croda |
| 5000 | oxirane, monobutyl ether | | | |
| SILCOLAPSE ® | Polydimethylsiloxanes and silica | 9016-00-6 | | BLUESTAR |
| 454 | | | | SILICONES |
| RHODOPOL ® 23 | Polysaccharide | 11138-66-2 | | Solvay |
| ACTICIDE ® | Mixture of 2-methyl-4-isothiazolin-3- | 2682-20-4 | | Thor GmbH |
| MBS | one (MIT) and 1,2-benzisothiazolin-3- | 2634-33-5 | | |
| | one (BIT) in water | | | |
| Xanthan gum | Polysaccharide | 11138-66-2 | | |
| Sokalan K 30 | Polyvinylpyrrolidone | 9003-39-8 | | BASF |
| Supragil WP | Sodium diisopropyl naphthalene | 1322-93-6 | | Solvay |
| | sulfonate | | | |
| Morwet D-425 | Naphthalene sulphonate formaldehyde | 9008-63-3 | | Nouryon |
| | condensate Na salt | | | |
| Soprophor 4 D | Tristyrylphenol ethoxylate sulfate (16 | 119432-41-6 | | Solvay |
| 384 | EO) ammonium salt | | | |
| Rhodorsil Antim | absorbed polydimethyl siloxane | unknown | | Solvay |
| EP 6703 | antifoam | | | |
| Kaolin Tec 1 | Aluminiumhydrosilicate | 1318-74-7 | | Ziegler & |
| | | 1332-58-7 | | Co. GmbH |
| Sipernat 22 S | synthetic amorphous silica (silicon | 112926-00-8 | | Evonik |
| | dioxide) | 7631-86-9 | | |
| RHODACAL ® | Calcium-dodecylbenzenesulphonate in | 26264-06-2 | | Solvay |
| 60 BE | 2-Ethylhexanol | 104-76-7 | | |
| Emulsogen ® EL | Ethoxylated Castor Oil with 40 EO | 61791-12-6 | | Clariant |
| 400 | | | | |
| ETOCAS ® 10 | Ethoxylated Castor Oil with 10 EO | 61791-12-6 | | Croda |
| TritonGR 7Me | Dioctylsulfosuccinate Sodium-Salt ca. | 577-11-7 | | DOW |
| | 65% in Solvent Naphtha light | | | |
| Solvesso ® | Mixture of aromatic hydrocarbons | 64742-94-5 | | ExxonMobil |
| 200ND | (C9-C11), naphtalene depleted | | | |
| Propylene | Propylene carbonate | 108-32-7 | | BASF |
| carbonate | | | | |
| Calsogen ® | Calcium | 11117-11-6 | | Clariant |
| AR100 | bis(tetrapropylenebenzenesulphonate) | | | |
| | In Heavy aromatic solvent naphtha | | | |
| Bentone ® 34 | Bis(hydrogenated tallow | 68953-58-2 | | Elementis |
| | alkyl)dimethyl ammonium bentonite | | | Specialities |
| | salts | | | |
| Silcolapse 482 | Dimethyl siloxanes and silicones | 63148-62-9 | | Bluestar |
| | | | | Silicones |

Herbicides

### EXAMPLE HB1: SC

TABLE HB5
Recipes HB1, HB2 and HB3.

| | | Recipe HB2 | Recipe HB3 |
|---|---|---|---|
| | Recipe HB1 | according to | according to |
| Component (g/l) | reference | the invention | the invention |
| Tembotrione (a) | 100 | 100 | 100 |
| Isoxadifen-ethyl (a) | 50 | 50 | 50 |
| ATLAS ® G 5000 (c) | 10.5 | 10.5 | 10.5 |
| Synperonic ® A7 (c) | 10.5 | 10.5 | 10.5 |
| Atlox ® 4913 (c) | 31.5 | 31.5 | 31.5 |
| Silwet ® HS 312 (b) | 0 | 50 | 0 |
| Silwet ® HS 604 (b) | 0 | 0 | 40 |
| Xanthan (c) | 1.9 | 1.9 | 1.9 |
| Acticide ® MBS (c) | 2.1 | 2.1 | 2.1 |
| Propylene glycol (c) | 52.5 | 52.5 | 52.5 |
| SILCOLAPSE ® 454 (c) | 2.44 | 2.44 | 2.44 |
| Water (d) (add to 1 litre) | to volume | to volume | to volume |

Dose rate 1 L/ha

The method of preparation used was according to Method 1.

Spray Coverage Tests on Leaves

The leaf coverage was determined according to the coverage method 6.

TABLE HB6
Spray deposit coverage and dose on non-textured leaves.

| | Leaf | Leaf | Leaf | Organosilicone | Organosilicone |
|---|---|---|---|---|---|
| | coverage % | coverage % | coverage % | surfactant dose | surfactant dose |
| Recipe | apple | corn | abutilon | g/ha | % w/v |
| Recipe HB1 not | 10.2 | 17.4 | 14.6 | 0 | 0 |
| according to the | | | | | |
| invention-10 l/ha | | | | | |
| Recipe HB1 not | 40.2 | 34.2 | 26.6 | 0 | 0 |
| according to the | | | | | |
| invention-200 l/ha | | | | | |
| Recipe HB2 | 30.8 | 28.8 | 24.6 | 50 | 0.5 |
| according to the | | | | | |
| invention-10 l/ha | | | | | |
| Recipe HB2 | 47.3 | 42.2 | 31 | 50 | 0.025 |
| according to the | | | | | |
| invention-200 l/ha | | | | | |
| Recipe HB3 | 13.8 | 15.6 | 16.1 | 40 | 0.4 |
| according to the | | | | | |
| invention-10 l/ha | | | | | |
| Recipe HB3 | 54.9 | 34.1 | 33.5 | 40 | 0.02 |
| according to the | | | | | |
| invention-200 l/ha | | | | | |

Formulations applied at 1 l/ha.

The results show that on non-structured leaves the coverage is higher at higher water application volumes.

TABLE HB7
Spray deposit coverage and dose on textured leaves.

| | Leaf | Leaf | Organosilicone | Organosilicone |
|---|---|---|---|---|
| | coverage % | coverage % | surfactant dose | surfactant dose |
| Recipe | barley | soybean | g/ha | % w/v |
| Recipe HB1 not | 23.7 | 13.2 | 0 | 0 |
| according to the | | | | |
| invention-10 l/ha | | | | |
| Recipe HB1 not | 12 | 25.2 | 0 | 0 |
| according to the | | | | |
| invention-200 l/ha | | | | |
| Recipe HB2 | 49.1 | 33.2 | 50 | 0.5 |
| according to the | | | | |
| invention-10 l/ha | | | | |
| Recipe HB2 | 29.4 | 35.3 | 50 | 0.025 |
| according to the | | | | |
| invention-200 l/ha | | | | |
| Recipe HB3 | 55.7 | 39.2 | 40 | 0.4 |
| according to the | | | | |
| invention-10 l/ha | | | | |
| Recipe HB3 | 29.6 | 39.6 | 40 | 0.02 |
| according to the | | | | |
| invention-200 l/ha | | | | |

Formulations applied at 1 l/ha.

The results show that recipes HB2 and HB3 illustrative of the invention show greater or same coverage at 10 L/ha spray volume as at 200 L/ha on textured leaves and also compared to the reference recipe HB1 on both types of leaves.

Greenhouse

Efficacy Data

TABLE HB8
Organosilicone super-spreader dose g/ha for each treatment.

| | | | | Recipe HB2 | Recipe HB3 |
|---|---|---|---|---|---|
| Spray volume | Rate of SC | Rate of a.i. | Recipe HB1 | according to | according to |
| l/ha | applied l/ha | g/ha | reference | the invention | the invention |
| 200 | 0.667 | 33.3 + 66.7 | 33.3 | 33.3 | 26.7 |
| 200 | 0.333 | 16.7 + 33.3 | 16.7 | 16.7 | 13.3 |
| 200 | 0.167 | 8.3 + 16.7 | 8.3 | 8.3 | 6.7 |
| 10 | 0.667 | 33.3 + 66.7 | 33.3 | 33.3 | 26.7 |
| 10 | 0.333 | 16.7 + 33.3 | 16.7 | 16.7 | 13.3 |
| 10 | 0.167 | 8.3 + 16.7 | 8.3 | 8.3 | 6.7 |

TABLE HB9
Organosilicone super-spreader dose g/ha and dose % w/v for 10 and 200 l/ha.

| | | | |
|---|---|---|---|
| | | Organosilicone | Organosilicone |
| Spray volume | Rate of SC | surfactant dose | surfactant dose |
| l/ha | applied l/ha | g/ha | % w/v |

HB1 reference

| | | | |
|---|---|---|---|
| 200 | 0.667 | 0 | 0 |
| 200 | 0.333 | 0 | 0 |
| 200 | 0.167 | 0 | 0 |
| 10 | 0.667 | 0 | 0 |
| 10 | 0.333 | 0 | 0 |
| 10 | 0.167 | 0 | 0 |

HB2

| | | | |
|---|---|---|---|
| 200 | 0.667 | 33 | 0.017 |
| 200 | 0.333 | 17 | 0.009 |
| 200 | 0.167 | 9 | 0.005 |
| 10 | 0.667 | 33 | 0.33 |
| 10 | 0.333 | 17 | 0.17 |
| 10 | 0.167 | 9 | 0.08 |

HB3

| | | | |
|---|---|---|---|
| 200 | 0.667 | 27 | 0.013 |
| 200 | 0.333 | 14 | 0.007 |
| 200 | 0.167 | 7 | 0.004 |
| 10 | 0.667 | 27 | 0.27 |
| 10 | 0.333 | 14 | 0.14 |
| 10 | 0.167 | 7 | 0.07 |

TABLE HB10
Biological efficacy on Setaria viridis (SETVI).

| | | | | Recipe HB2 | Recipe HB3 |
|---|---|---|---|---|---|
| Spray volume | Rate of SC | Rate of a.i. | Recipe HB1 | according to | according to |
| l/ha | applied l/ha | g/ha | reference | the invention | the invention |
| 200 | 0.667 | 33.3 + 66.7 | 20 | 30 | — |
| 200 | 0.333 | 16.7 + 33.3 | 20 | 30 | 15 |
| 10 | 0.667 | 33.3 + 66.7 | 30 | 40 | — |
| 10 | 0.333 | 16.7 + 33.3 | 20 | 38 | 30 |

TABLE HB11
Biological efficacy on Echinochloa crus-galli (ECHCG).

| | | | | Recipe HB2 | Recipe HB3 |
|---|---|---|---|---|---|
| Spray volume | Rate of SC | Rate of a.i. | Recipe HB1 | according to | according to |
| l/ha | applied l/ha | g/ha | reference | the invention | the invention |
| 200 | 0.667 | 33.3 + 66.7 | 98 | 95 | 96 |
| 200 | 0.333 | 16.7 + 33.3 | 80 | 95 | 90 |
| 200 | 0.167 | 8.3 + 16.7 | — | 40 | 10 |
| 10 | 0.667 | 33.3 + 66.7 | 80 | 96 | 96 |
| 10 | 0.333 | 16.7 + 33.3 | 83 | 94 | 96 |
| 10 | 0.167 | 8.3 + 16.7 | — | 70 | 78 |

The results in table HB10 and HB11 show that recipes HB2 and HB3 illustrative of the invention show greater or same efficacy at 10 L/ha spray volume as at 200 L/ha on different weeds and also compared to the reference recipe HB1. The effect is stronger on lower rates of active.

TABLE HB12
Organosilicone super-spreader dose g/ha for each treatment.

| | | | | |
|---|---|---|---|---|
| | | | Organosilicone | Organosilicone |
| Spray volume | Rate of SC | Rate of a.i. | surfactant dose | surfactant dose |
| l/ha | applied l/ha | g/ha | g/ha | % w/v |

HB1 reference

| | | | | |
|---|---|---|---|---|
| 200 | 1 | 50 + 100 | 0 | 0 |
| 10 | 1 | 50 + 100 | 0 | 0 |

HB2

| | | | | |
|---|---|---|---|---|
| 200 | 1 | 50 + 100 | 50 | 0.025 |
| 10 | 1 | 50 + 100 | 50 | 0.5 |

HB3

| | | | | |
|---|---|---|---|---|
| 200 | 1 | 50 + 100 | 40 | 0.02 |
| 10 | 1 | 50 + 100 | 40 | 0.4 |

TABLE HB13
Biological efficacy on Echinochloa crus-galli (ECHCG)

| | | Recipe HB2 | Recipe HB3 |
|---|---|---|---|
| | Recipe HB1 | according to | according to |
| | reference | the invention | the invention |
| 200 l/ha | 96 | 95 | 96 |
| 10 l/ha | 80 | 96 | 96 |

TABLE HB14
Biological efficacy on Alopecurus myosuroides (ALOMY)

| | | Recipe HB2 | Recipe HB3 |
|---|---|---|---|
| | Recipe HB1 | according to | according to |
| | reference | the invention | the invention |
| 200 l/ha | 60 | 96 | — |
| 10 l/ha | 8 | 82 | — |

TABLE HB15
Biological efficacy on Amaranthus retroflexus (AMARE)

| | | Recipe HB2 | Recipe HB3 |
|---|---|---|---|
| | Recipe HB1 | according to | according to |
| | reference | the invention | the invention |
| 200 l/ha | 98 | 99 | 96 |
| 10 l/ha | 48 | 99 | 90 |

TABLE HB16
Biological efficacy on Abutilon theophrasti (ABUTH)

| | | Recipe HB2 | Recipe HB3 |
|---|---|---|---|
| | Recipe HB1 | according to | according to |
| | reference | the invention | the invention |
| 200 l/ha | 88 | 88 | 88 |
| 10 l/ha | 60 | 88 | 90 |

The results in table HB13-16 show that recipes HB2 and HB3 illustrative of the invention show greater or same efficacy at 10 L/ha spray volume as at 200 L/ha on different weeds and also compared to the reference recipe HB1.

### EXAMPLE HB2: WG

TABLE HB17
Recipes HB4, HB5

| | | Recipe HB5 |
|---|---|---|
| | Recipe HB4 | according to |
| Component (g/kg) | reference | the invention |
| Indaziflam (a) | 200 | 200 |
| Triafamone (a) | 200 | 200 |
| Supragil WP (c) | 50 | 50 |
| Morwet D 425 (c) | 200 | 200 |
| Sokalan K 30 (c) | 20 | 20 |
| Silwet 408 (b) | 0 | 80 |
| Rhodorsil Antim EP 6703 (c) | 40 | 40 |
| Sipernat 22 S (c) | 50 | 50 |
| Kaolin Tec 1 (d) | 240 | 160 |

Dose rate: 0.25 kg/ha

The method of preparation used was according to Method 2.

Spray Coverage and Pipette Spreading Tests on Leaves

The leaf coverage was determined according to the coverage method.

TABLE HB18
Spray deposit coverage and dose on non-textured leaves.

| | | | | | | Organo- |
|---|---|---|---|---|---|---|
| | Leaf | Leaf | | | Organo- | silicone |
| | coverage | coverage | Deposit | Deposit | silicone | surfactant |
| | % | % | area mm^{∧}2 | area mm^{∧}2 | surfactant | dose % |
| Recipe | apple | corn | amaranthus | abutilon | dose g/ha | w/v |
| Recipe HB4 not | 1.7 | 2.8 | 7.16 | 5.4 | 0 | 0 |
| according to the | | | | | | |
| invention - 10 l/ha | | | | | | |
| Recipe HB4 not | | | 5.8 | 5.5 | 0 | 0 |
| according to the | | | | | | |
| invention - 40 l/ha | | | | | | |
| Recipe HB4 not | 8.4 | 10.8 | 4.5 | 6.1 | 0 | 0 |
| according to the | | | | | | |
| invention - 200 l/ha | | | | | | |
| Recipe HB4 not | | | 4.1 | 4.7 | 0 | 0 |
| according to the | | | | | | |
| invention - 500 l/ha | | | | | | |
| Recipe HB5 according to | 2.1 | 5.3 | 12.2 | 14.1 | 20 | 0.2 |
| the invention - 10 l/ha | | | | | | |
| Recipe HB5 according to | | | 12.1 | 15.4 | 20 | 0.05 |
| the invention- 40 l/ha | | | | | | |
| Recipe HB5 according to | 8.4 | 9.2 | 8.5 | 12.7 | 20 | 0.01 |
| the invention - 200 l/ha | | | | | | |
| Recipe HB5 according to | | | 5.6 | 9.4 | 20 | 0.004 |
| the invention - 500 l/ha | | | | | | |

Dose rate: 0.25 kg/ha

The results show that on non-structured leaves the leaf-coverage is higher or similar at higher water application volumes on apple and corn.

But the deposit area on amaranthus and abutilon is according to the patent greater at lower spray-volume (10 l/ha) and also better compared to the reference-formulation.

TABLE HB19
Spray deposit coverage and dose on textured leaves.

| | | | | | | Organo- | Organo- |
|---|---|---|---|---|---|---|---|
| | Leaf | Leaf | Leaf | Deposit | Deposit | silicone | silicone |
| | coverage | coverage | coverage | area | area | surfactant | surfactant |
| | % | % | % | mm^{∧}2 | mm^{∧}2 | dose | dose |
| Recipe | soybean | barley | rice | chenopodium | digitaria | g/ha | % w/v |
| Recipe HB4 not | 1 | 1.1 | 0.7 | 1.4 | 0.9 | 0 | 0 |
| according to the | | | | | | | |
| invention - 10 | | | | | | | |
| l/ha | | | | | | | |
| Recipe HB4 not | | | | 1.1 | 1.2 | 0 | 0 |
| according to the | | | | | | | |
| invention - 40 | | | | | | | |
| l/ha | | | | | | | |
| Recipe HB4 not | 2.7 | 0.7 | 1.2 | 1.8 | 1.4 | 0 | 0 |
| according to the | | | | | | | |
| invention - 200 | | | | | | | |
| l/ha | | | | | | | |
| Recipe HB4 not | | | | 1.1 | 1.8 | 0 | 0 |
| according to the | | | | | | | |
| invention - 500 | | | | | | | |
| l/ha | | | | | | | |
| Recipe HB5 | 9.2 | 16.5 | 8.7 | 101* | 114 | 20 | 0.2 |
| according to the | | | | | | | |
| invention - 10 | | | | | | | |
| l/ha | | | | | | | |
| Recipe HB5 | | | | 47.5 | 67.6 | 20 | 0.05 |
| according to the | | | | | | | |
| invention - 40 | | | | | | | |
| l/ha | | | | | | | |
| Recipe HB5 | 7 | 1.5 | 3.2 | 14.6 | 10.4 | 20 | 0.01 |
| according to the | | | | | | | |
| invention - 200 | | | | | | | |
| l/ha | | | | | | | |
| Recipe HB5 | | | | 6.8 | 6.8 | 20 | 0.004 |
| according to the | | | | | | | |
| invention - 500 | | | | | | | |
| l/ha | | | | | | | |

Dose rate: 0.25 kg/ha

Numbers with asterisk mean that drops spread over the whole leave and the covered area (coverage) might be limited by the leaf area and not by lack of surfactants in the formulation.

The results show that recipe HB5 illustrative of the invention shows greater leaf-coverage and deposit area at 10 L/ha spray volume than at 200 L/ha or 500 L/ha on textured leaves and also compared to the reference recipe HB4.

### EXAMPLE HB3: WG

TABLE HB20
Recipes HB6 and HB7.

| | | Recipe HB7 |
|---|---|---|
| | Recipe HB6 | according to |
| Component (g/kg) | reference | the invention |
| Mesosulfuron-methyl sodium (a) | 23.48 | 23.48 |
| Mefenpyr-diethyl (a) | 45 | 45 |
| Supragil WP (c) | 30 | 30 |
| Morwet D-425 (c) | 150 | 150 |
| Soprophor 4 D 384 (c) | 40 | 40 |
| Sokalan K 30 (c) | 20 | 20 |
| Silwet 408 (b) | 0 | 80 |
| Rhodorsil Antim EP 6703 (c) | 20 | 20 |
| Kaolin Tec 1 (d) | 671.52 | 591.52 |

Dose rate: 0.5 kg/ha

The method of preparation used was according to Method 2.

Spray Coverage Tests on Leaves

The leaf coverage was determined according to the coverage method.

TABLE HB21
Spray deposit coverage and dose on non-textured leaves.

| | Leaf | Leaf | Leaf | Organo- | Organo- |
|---|---|---|---|---|---|
| | cover- | cover- | cover- | silicone | silicone |
| | age % | age % | age % | surfactant | surfactant |
| | apple | apple | abutilon | dose | dose |
| Recipe | at 0° | at 60° | at 0° | g/ha | % w/v |
| Recipe HB6 not | 4.7 | 2.1 | 6.9 | 0 | 0 |
| according to the | | | | | |
| invention-10 l/ha | | | | | |
| Recipe HB6 not | 6.4 | 3 | 5.5 | 0 | 0 |
| according to the | | | | | |
| invention-20 l/ha | | | | | |
| Recipe HB6 not | 14.7 | 7.3 | 13.2 | 0 | 0 |
| according to the | | | | | |
| invention-500 l/ha | | | | | |
| Recipe HB7 | 26.9 | 6.1 | 15.5 | 40 | 0.4 |
| according to the | | | | | |
| invention-10 l/ha | | | | | |
| Recipe HB7 | 12.7 | 4.8 | 19.7 | 40 | 0.2 |
| according to the | | | | | |
| invention-20 l/ha | | | | | |
| Recipe HB7 | 44.7 | 24.9 | 46.5 | 40 | 0.008 |
| according to the | | | | | |
| invention-500 l/ha | | | | | |

Dose rate: 0.5 kg/ha

The results show that on non-structured leaves the coverage is higher at higher water application volumes.

TABLE HB22
Spray deposit coverage and dose on textured leaves.

| | Leaf | Leaf | Leaf | Leaf | | |
|---|---|---|---|---|---|---|
| | coverage | coverage | coverage | coverage | | |
| | % | % | % | % | Organosilicone | Organosilicone |
| | soybean | soybean | barley at | rice at | surfactant | surfactant |
| Recipe | at 0° | at 60° | 0° | 0° | dose g/ha | dose % w/v |
| Recipe HB6 | 3.5 | 2.7 | 2.8 | 2.8 | 0 | 0 |
| not according | | | | | | |
| to the | | | | | | |
| invention - 10 | | | | | | |
| l/ha | | | | | | |
| Recipe HB6 | 3.8 | 2 | 5.5 | 4.4 | 0 | 0 |
| not according | | | | | | |
| to the | | | | | | |
| invention - 20 | | | | | | |
| l/ha | | | | | | |
| Recipe HB6 | | | | | 0 | 0 |
| not according | | | | | | |
| to the | | | | | | |
| invention - 40 | | | | | | |
| l/ha | | | | | | |
| Recipe HB6 | | | | | 0 | 0 |
| not according | | | | | | |
| to the | | | | | | |
| invention - | | | | | | |
| 200 l/ha | | | | | | |
| Recipe HB6 | 4.8 | 1.2 | 5.8 | 4.8 | 0 | 0 |
| not according | | | | | | |
| to the | | | | | | |
| invention - | | | | | | |
| 500 l/ha | | | | | | |
| RecipeHB7 | 37.9 | 19.7 | 25.4 | 21 | 40 | 0.4 |
| according to | | | | | | |
| the invention - | | | | | | |
| 10 l/ha | | | | | | |
| Recipe HB7 | 33.5 | 13 | 25.7 | 28.7 | 40 | 0.2 |
| according to | | | | | | |
| the invention n- | | | | | | |
| 20 l/ha | | | | | | |
| Recipe HB7 | | | | | 40 | 0.1 |
| according to | | | | | | |
| the invention - | | | | | | |
| 40 l/ha | | | | | | |
| Recipe HB7 | | | | | 40 | 0.02 |
| according to | | | | | | |
| the invention - | | | | | | |
| 200 l/ha | | | | | | |
| Recipe HB7 | 11 | 1.8 | 20 | 14 | 40 | 0.008 |
| according to | | | | | | |
| the invention - | | | | | | |
| 500 l/ha | | | | | | |

Dose rate: 0.5 kg/ha

TABLE HB22a
Spray deposit coverage and dose on textured leaves.

| | Leaf | Leaf | | |
|---|---|---|---|---|
| | cover- | cover- | | |
| | age % | age % | Organo- | Organo- |
| | corn | corn | silicone | silicone |
| | (BBCH- | (BBCH- | surfactant | surfactant |
| | 11/14) | 11/14) | dose | dose |
| Recipe | at 0° | at 60° | g/ha | % w/v |
| Recipe HB6 | 6.5 | 3.6 | 0 | 0 |
| not according | | | | |
| to the | | | | |
| invention-10 | | | | |
| l/ha | | | | |
| Recipe HB6 | 11.5 | 7.2 | 0 | 0 |
| not according | | | | |
| to the | | | | |
| invention-20 | | | | |
| l/ha | | | | |
| Recipe HB6 | | | 0 | 0 |
| not according | | | | |
| to the | | | | |
| invention-40 | | | | |
| l/ha | | | | |
| Recipe HB6 | | | 0 | 0 |
| not according | | | | |
| to the | | | | |
| invention-200 | | | | |
| l/ha | | | | |
| Recipe HB6 | 29.1 | 20 | 0 | 0 |
| not according | | | | |
| to the | | | | |
| invention-500 | | | | |
| l/ha | | | | |
| Recipe HB7 | 37.9 | 19.7 | 40 | 0.4 |
| according to | | | | |
| the invention- | | | | |
| 10 l/ha | | | | |
| Recipe HB7 | 33.5 | 13 | 40 | 0.2 |
| according to | | | | |
| the invention- | | | | |
| 20 l/ha | | | | |
| Recipe HB7 | | | 40 | 0.1 |
| according to | | | | |
| the invention- | | | | |
| 40 l/ha | | | | |
| Recipe HB7 | | | 40 | 0.02 |
| according to | | | | |
| the invention- | | | | |
| 200 l/ha | | | | |
| Recipe HB7 | 11 | 1.8 | 40 | 0.008 |
| according to | | | | |
| the invention- | | | | |
| 500 l/ha | | | | |

Dose rate: 0.5 kg/ha

TABLE HB22b
Spray deposit coverage and dose on textured leaves.

| | | | Organo- | Organo- |
|---|---|---|---|---|
| | Deposit | Deposit | silicone | silicone |
| | area | area | surfactant | surfactant |
| | mm\hat{ }2 | mm\hat{ }2 | dose | dose |
| Recipe | chenopodium | digitaria | g/ha | % w/v |
| Recipe HB6 | 3.2 | 4.3 | 0 | 0 |
| not according | | | | |
| to the | | | | |
| invention-10 | | | | |
| l/ha | | | | |
| Recipe HB6 | 4 | 2.4 | 0 | 0 |
| not according | | | | |
| to the | | | | |
| invention-20 | | | | |
| l/ha | | | | |
| Recipe HB6 | 2.4 | 1.9 | 0 | 0 |
| not according | | | | |
| to the | | | | |
| invention-40 | | | | |
| l/ha | | | | |
| Recipe HB6 | 1.9 | 1.9 | 0 | 0 |
| not according | | | | |
| to the | | | | |
| invention- | | | | |
| 200 l/ha | | | | |
| Recipe HB6 | 1.6 | 1.9 | 0 | 0 |
| not according | | | | |
| to the | | | | |
| invention- | | | | |
| 500 l/ha | | | | |
| Recipe HB7 | 250* | 314 | 40 | 0.4 |
| according to | | | | |
| the invention- | | | | |
| 10 l/ha | | | | |
| Recipe HB7 | 250* | 308 | 40 | 0.2 |
| according to | | | | |
| the invention- | | | | |
| l/ha | | | | |
| Recipe HB7 | 100 | 186 | 40 | 0.1 |
| according to | | | | |
| the invention- | | | | |
| 40 l/ha | | | | |
| Recipe HB7 | 23.8 | 43.8 | 40 | 0.02 |
| according to | | | | |
| the invention- | | | | |
| 200 l/ha | | | | |
| Recipe HB7 | 5.8 | 16.2 | 40 | 0.008 |
| according to | | | | |
| the invention- | | | | |
| 500 l/ha | | | | |

Dose rate: 0.5 kg/ha

Numbers with asterisk mean that drops spread over the whole leave and the covered area (coverage) might be limited by the leaf area and not by lack of surfactants in the formulation.

The results show that recipe HB7 illustrative of the invention shows greater leaf-coverage and deposit area at 10 L/ha, 20 L/ha and 40 l/ha spray volume as at 200 L/ha or 500 L/ha on textured leaves and also compared to the reference recipe HB6.

### EXAMPLE HB4: EC

TABLE HB23
Recipes HB8, HB9, HB10 and HB11.

| | | Recipe HB9 | | Recipe HB11 |
|---|---|---|---|---|
| | Recipe HB8 | according to | Recipe HB10 | according to |
| Component (g/l) | reference | the invention | reference | the invention |
| FENOXAPROP-P-ETHYL (a) | 90 | 90 | 90 | 90 |
| MEFENPYR-DIETHYL (a) | 45 | 45 | 45 | 45 |
| Rhodacal ® 60 BE (c) | 41 | 41 | 41 | 41 |
| Etocas ® 10 (c) | 0 | 0 | 62 | 62 |
| Emulsogen ® EL 400 (c) | 62 | 62 | 0 | 0 |
| SILWET ® 806 (b) | 0 | 41 | 0 | 41 |
| SOLVESSO ® 200 ND (d) | to volume | to volume | to volume | to volume |
| (add to 1 litre) | | | | |

Dose rate: 0.25 L/ha and 1 L/ha

The method of preparation used was according to Method 3.

Results

Spray Coverage Tests on Leaves

The leaf coverage was determined according to coverage method.

TABLE HB24
Spray deposit coverage and dose on non-textured leaves.

| | Leaf | Leaf | Organo- | Organo- |
|---|---|---|---|---|
| | cover- | cover- | silicone | silicone |
| | age % | age % | surfactant | surfactant |
| | apple at | apple at | dose | dose |
| Recipe | 0° | 60° | g/ha | % w/v |
| Recipe | 1.8 | 2 | 0 | 0 |
| HB8 not | | | | |
| according | | | | |
| to the | | | | |
| invention- | | | | |
| 10 l/ha | | | | |
| Recipe | 5.5 | 7.5 | 0 | 0 |
| HB8 not | | | | |
| according | | | | |
| to the | | | | |
| invention- | | | | |
| 200 l/ha | | | | |
| Recipe | 2.6 | 1.5 | 10 | 0.1 |
| HB9 | | | | |
| according | | | | |
| to the | | | | |
| invention- | | | | |
| 10 l/ha | | | | |
| Recipe | 12.7 | 1.9 | 10 | 0.005 |
| HbB9 | | | | |
| according | | | | |
| to the | | | | |
| invention- | | | | |
| 200 l/ha | | | | |

Dose rate: 0.25 kg/ha

The results show that on non-structured leaves the coverage is higher at higher water application volume.

TABLE HB25
Spray deposit coverage and dose on textured leaves.

| | Leaf | Leaf | | Leaf | | |
|---|---|---|---|---|---|---|
| | coverage % | coverage % | Leaf | coverage % | Organosilicone | Organosilicone |
| | soybean at | soybean at | coverage % | barley at | surfactant | surfactant |
| Recipe | 0° | 60° | barley at 0° | 60° | dose g/ha | dose % w/v |
| Recipe HB8 | 1.8 | 1.1 | 2.8 | 6.2 | 0 | 0 |
| not according | | | | | | |
| to the | | | | | | |
| invention - 10 | | | | | | |
| l/ha | | | | | | |
| Recipe HB8 | 7.1 | 0.7 | 5.4 | 1.2 | 0 | 0 |
| not according | | | | | | |
| to the | | | | | | |
| invention - | | | | | | |
| 200 l/ha | | | | | | |
| Recipe HB9 | 6.7 | 2.8 | 12.8 | 4.5 | 10 | 0.1 |
| according to | | | | | | |
| the invention - | | | | | | |
| 10 l/ha | | | | | | |
| Recipe HB9 | 5.7 | 0.4 | 3.9 | 1.3 | 10 | 0.005 |
| according to | | | | | | |
| the invention - | | | | | | |
| 200 l/ha | | | | | | |

Dose rate: 0.25 kg/ha

TABLE HB25a
Spray deposit coverage and dose on textured leaves.

| | Leaf | Leaf | Organo- | Organo- |
|---|---|---|---|---|
| | cover- | cover- | silicone | silicone |
| | age % | age % | surfactant | surfactant |
| | rice at | rice at | dose | dose |
| Recipe | 0° | 60° | g/ha | % w/v |
| Recipe HB8 | 2.1 | 1 | 0 | 0 |
| not according | | | | |
| to the | | | | |
| invention-10 | | | | |
| l/ha | | | | |
| Recipe HB8 | 4.8 | 1.2 | 0 | 0 |
| not according | | | | |
| to the | | | | |
| invention- | | | | |
| 200 l/ha | | | | |
| Recipe HB9 | 4.8 | 2.1 | 10 | 0.1 |
| according to | | | | |
| the invention- | | | | |
| 10 l/ha | | | | |
| Recipe HB9 | 4.2 | 0.7 | 10 | 0.005 |
| according to | | | | |
| the invention- | | | | |
| 200 l/ha | | | | |

Dose rate: 0.25 kg/ha

The results show that recipe HB9 illustrative of the invention shows greater coverage at 10 L/ha spray volume than at 200 L/ha on textured leaves and also compared to the reference recipe HB8.

Pipette Spreading Tests on Leaves

The deposit size was determined according to the coverage method.

TABLE HB26
Spray deposit size and dose on non-textured leaves.

| | | | Organo- | Organo- |
|---|---|---|---|---|
| | Deposit | Deposit | silicone | silicone |
| | area | area | surfactant | surfactant |
| | mm\hat{ }2 | mm\hat{ }2 | dose | dose |
| Recipe | amaranthus | abutilon | g/ha | % w/v |
| Recipe HB10 not | 7.6 | 7.6 | 0 | 0 |
| according to the | | | | |
| invention-10 l/ha | | | | |
| Recipe HB10 not | 5.1 | 6.5 | 0 | 0 |
| according to the | | | | |
| invention-200 | | | | |
| l/ha | | | | |
| Recipe HB11 | 8.0 | 12.2 | 10 | 0.1 |
| according to the | | | | |
| invention-10 l/ha | | | | |
| Recipe HB11 | 8.0 | 10.5 | 10 | 0.005 |
| according to the | | | | |
| invention-200 | | | | |
| l/ha | | | | |

Dose rate: 0.25 kg/ha

The results show that on non-structured leaves the coverage is similar at both water application volumes.

TABLE HB27
Spray deposit coverage and dose on textured leaves.

| | Deposit | | | Organo- | Organo- |
|---|---|---|---|---|---|
| | area | Deposit | Deposit | silicone | silicone |
| | mm\hat{ }2 | area | area | surfactant | surfactant |
| | caheno- | mm\hat{ }2 | mm\hat{ }2 | dose | dose |
| Recipe | podium | rice | digitaria | g/ha | % w/v |
| Recipe HB10 | 10.8 | 22.3 | 12.2 | 0 | 0 |
| not according | | | | | |
| to the | | | | | |
| invention- | | | | | |
| 10 l/ha | | | | | |
| Recipe HB10 | 2.7 | 3.5 | 5.2 | 0 | 0 |
| not according | | | | | |
| to the | | | | | |
| invention- | | | | | |
| 200 l/ha | | | | | |
| Recipe HB11 | 28.6 | 61.6 | 50.8 | 10 | 0.1 |
| according to | | | | | |
| the invention- | | | | | |
| 10 l/ha | | | | | |
| Recipe HB11 | 13.7 | 10.5 | 22.8 | 10 | 0.005 |
| according to | | | | | |
| the invention- | | | | | |
| 200 l/ha | | | | | |

Dose rate: 0.25 kg/ha

The results show that recipes HB11 illustrative of the invention shows greater coverage at 10 L/ha spray volume as at 200 L/ha on textured leaves and also compared to the reference recipe HB10.

Pipette Spreading Tests on Leaves

The deposit size was determined according to coverage method.

TABLE HB28
Spray dilution droplet size and dose on non-textured leaves.

| | | Organo- | Organo- |
|---|---|---|---|
| | Deposit | silicone | silicone |
| | area | surfactant | surfactant |
| | mm\hat{ }2 | dose | dose |
| Recipe | apple | g/ha | % w/v |
| Recipe HB8 not | 12.2 | 0 | 0 |
| according to the | | | |
| invention-10 l/ha | | | |
| Recipe HB8 not | 7.6 | 0 | 0 |
| according to the | | | |
| invention-200 l/ha | | | |
| Recipe HB9 | 12.7 | 41 | 0.41 |
| according | | | |
| to the invention- | | | |
| 10 l/ha | | | |
| Recipe HB9 | 11.5 | 41 | 0.02 |
| according | | | |
| to the invention- | | | |
| 200 l/ha | | | |

Formulations applied at 1 l/ha.

The results show that on non-structured leaves the coverage is similar at both water application volumes.

TABLE HB29
Spray dilution droplet size and dose on textured leaves.

| | | | | Organo- | Organo- |
|---|---|---|---|---|---|
| | Deposit | Deposit | Deposit | silicone | silicone |
| | area | area | area | surfactant | surfactant |
| | mm\hat{ }2 | mm\hat{ }2 | mm\hat{ }2 | dose | dose |
| Recipe | soybean | rice | barley | g/ha | % w/v |
| Recipe HB8 not | 52.3 | 191 | 34.3 | 0 | 0 |
| according to the | | | | | |
| invention-10 l/ha | | | | | |
| Recipe HB8 not | 5.75 | 25 | 7.7 | 0 | 0 |
| according to the | | | | | |
| invention-200 l/ha | | | | | |
| Recipe HB9 | 88.2 | 221 | 104 | 41 | 0.41 |
| according to the | | | | | |
| invention-10 l/ha | | | | | |
| Recipe HB9 | 49 | 70 | 42.4 | 41 | 0.02 |
| according to the | | | | | |
| invention-200 l/ha | | | | | |

Formulations applied at 1 l/ha.

The results show that on structured leaves recipe HB9 illustrative of the invention shows larger deposit sizes at 10 L/ha spray volume than at 200 L/ha and also compared to the reference recipe HB8.

TABLE HB30
Spray dilution droplet size and dose on non-textured leaves.

| | | Organo- | Organo- |
|---|---|---|---|
| | Deposit | silicone | silicone |
| | area | surfactant | surfactant |
| | mm\hat{ }2 | dose | dose |
| Recipe | apple | g/ha | % w/v |
| Recipe HB10 not | 14.3 | 0 | 0 |
| according to the | | | |
| invention-10 l/ha | | | |
| Recipe HB10 not | 7.5 | 0 | 0 |
| according to the | | | |
| invention-200 l/ha | | | |
| Recipe HB11 | 14.6 | 41 | 0.41 |
| according | | | |
| to the invention- | | | |
| 10 l/ha | | | |
| Recipe HB11 | 9.8 | 41 | 0.02 |
| according | | | |
| to the invention- | | | |
| 200 l/ha | | | |

Formulations applied at 1 l/ha.

The results show that on non-structured leaves deposit size is slightly higher at lower application volume.

TABLE HB31
Spray dilution droplet size and dose on textured leaves.

| | | | | Organo- | Organo- |
|---|---|---|---|---|---|
| | Deposit | Deposit | Deposit | silicone | silicone |
| | area | area | area | surfactant | surfactant |
| | mm\hat{ }2 | mm\hat{ }2 | mm\hat{ }2 | dose | dose |
| Recipe | soybean | rice | barley | g/ha | % w/v |
| Recipe HB10 not | 51.3 | 143 | 39.2 | 0 | 0 |
| according to the | | | | | |
| invention-10 l/ha | | | | | |
| Recipe HB10 not | 5.8 | 17.4 | 14.6 | 0 | 0 |
| according to the | | | | | |
| invention-200 l/ha | | | | | |
| Recipe HB11 | 122 | 152 | 83 | 41 | 0.41 |
| according to the | | | | | |
| invention- | | | | | |
| 10 l/ha | | | | | |
| Recipe HB11 | 35 | 41.4 | 25.5 | 41 | 0.02 |
| according to the | | | | | |
| invention- | | | | | |
| 200 l/ha | | | | | |

Formulations applied at 1 l/ha.

The results show that recipes HB11 illustrative of the invention shows greater coverage at 10 L/ha spray volume as at 200 L/ha on textured leaves and also compared to the reference recipe HB10.

Greenhouse

Efficacy Data

TABLE HB32
Biological efficacy on Alopecurus myosuroides (ALOMY).

| | Rate | | | Recipe |
|---|---|---|---|---|
| Spray | of SL | Rate | Recipe | HB11 |
| volume | applied | of a.i. | HB10 | according to |
| l/ha | l/ha | g/ha | reference | the invention |
| 200 | 1 | 90 + 45 | 60 | 86 |
| 10 | 1 | 90 + 45 | 92 | 97 |

TABLE HB32a
Biological efficacy on Avena fatua (AVEFA).

| | Rate | | | Recipe |
|---|---|---|---|---|
| Spray | of SL | Rate | Recipe | HB11 |
| volume | applied | of a.i. | HB10 | according to |
| l/ha | l/ha | g/ha | reference | the invention |
| 200 | 1 | 90 + 45 | 60 | 72 |
| 10 | 1 | 90 + 45 | 80 | 100 |

TABLE HB32b
Biological efficacy on Lolium rigidum (LOLRI).

| | Rate | | | Recipe |
|---|---|---|---|---|
| Spray | of SL | Rate | Recipe | HB11 |
| volume | applied | of a.i. | HB10 | according to |
| l/ha | l/ha | g/ha | reference | the invention |
| 200 | 1 | 90 + 45 | 0 | 0 |
| 10 | 1 | 90 + 45 | 5 | 48 |

The results in table HB32 HB32a and HB32b show that recipe HB11 illustrative of the invention show greater efficacy at 10 L/ha spray volume as at 200 L/ha on different weeds and also compared to the reference recipe HB10.

### EXAMPLE HB5: OD

TABLE HB33
Recipes HB12 and HB13.

| | | Recipe |
|---|---|---|
| | | HB13 |
| | Recipe | according |
| | HB12 | to the |
| Component (g/l) | reference | invention |
| THIENCARBAZONE-METHYL | 10 | 10 |
| (a) | | |
| MEFENPYR-DIETHYL (a) | 60 | 60 |
| Calsogen AR 100 ® 60 BE (c) | 80 | 80 |
| Emulsogen ® EL 400 (c) | 60 | 60 |
| Bentone ® 34 (c) | 20 | 20 |
| PROPYLENE CARBONATE (c) | 2 | 2 |
| SILWET ® 408 (b) | 0 | 50 |
| SILCOLAPSE ® 482 (c) | 1.5 | 1.5 |
| SODIUM CARBONATE (c) | 2 | 2 |
| SOLVESSO ® 200 ND (d) | to | to |
| (add to 1 litre) | volume | volume |

Dose rate 0.5 L/ha

The method of preparation used was according to Method 4.

Spray Coverage Tests on Leaves

The leaf coverage was determined according to coverage method.

TABLE HB34
Spray deposit coverage and dose on non-textured leaves.

| | Leaf | Leaf | | | | |
|---|---|---|---|---|---|---|
| | coverage | coverage | Leaf | Leaf | Organosilicone | Organosilicone |
| | % | % | coverage % | coverage % | surfactant | surfactant |
| | apple at | apple at | amaranthus | amaranthus | dose | dose |
| Recipe | 0° | 60° | at 0° | at 60° | g/ha | % w/v |
| Recipe HB12 | 2.8 | 3.4 | 14.4 | 1.8 | 0 | 0 |
| not according | | | | | | |
| to the | | | | | | |
| invention - | | | | | | |
| 10 l/ha | | | | | | |
| Recipe HB12 | 10.7 | 5.1 | 16.4 | 6.4 | 0 | 0 |
| not according | | | | | | |
| to the | | | | | | |
| invention - | | | | | | |
| 200 l/ha | | | | | | |
| Recipe HB13 | 4.6 | 5.6 | 3 | 0.9 | 25 | 0.25 |
| according to | | | | | | |
| the invention - | | | | | | |
| 10 l/ha | | | | | | |
| Recipe HB13 | 14.4 | 13.9 | 20.8 | 6.2 | 25 | 0.0125 |
| according to | | | | | | |
| the invention - | | | | | | |
| 200 l/ha | | | | | | |

Dose rate: 0.5 kg/ha

TABLE HB34a
Spray deposit coverage and dose on non-textured leaves.

| | Leaf | Leaf | Organo- | Organo- |
|---|---|---|---|---|
| | coverage | coverage | silicone | silicone |
| | % | % | surfactant | surfactant |
| | abutilon | abutilon | dose | dose |
| Recipe | s at 0° | s at 60° | g/ha | % w/v |
| Recipe HB12 | 5.6 | 2.4 | 0 | 0 |
| not according | | | | |
| to the | | | | |
| invention-10 | | | | |
| l/ha | | | | |
| Recipe HB12 | 16.9 | 9.2 | 0 | 0 |
| not according | | | | |
| to the | | | | |
| invention- | | | | |
| 200 l/ha | | | | |
| Recipe HB13 | 9.1 | 3.3 | 25 | 0.25 |
| according to | | | | |
| the invention- | | | | |
| 10 l/ha | | | | |
| Recipe HB13 | 33.7 | 5.3 | 25 | 0.0125 |
| according to | | | | |
| the invention- | | | | |
| 200 l/ha | | | | |

Dose rate: 0.5 kg/ha

The results show that on non-structured leaves the coverage is higher or at higher water application volumes.

TABLE HB35
Spray deposit coverage and dose on textured leaves.

| | Leaf | Leaf | Leaf | Leaf | Organo- | Organo- |
|---|---|---|---|---|---|---|
| | coverage | coverage | coverage | coverage | silicone | silicone |
| | % | % | % | % | surfactant | surfactant |
| | rice at | rice at | digitaria | digitaria | dose | dose |
| Recipe | 0° | 60° | at 0° | at 60° | g/ha | % w/v |
| Recipe HB12 | 21.5 | 2.2 | 15.9 | 4.4 | 0 | 0 |
| not according | | | | | | |
| to the | | | | | | |
| invention-10 | | | | | | |
| l/ha | | | | | | |
| Recipe HB12 | 4.9 | 0.7 | 7.6 | 3.6 | 0 | 0 |
| not according | | | | | | |
| to the | | | | | | |
| invention- | | | | | | |
| 200 l/ha | | | | | | |
| Recipe HB13 | 23.2 | 2.4 | 17.9 | 14 | 25 | 0.25 |
| according to | | | | | | |
| the invention- | | | | | | |
| 10 l/ha | | | | | | |
| Recipe HB13 | 5.8 | 0.6 | 11 | 4.9 | 25 | 0.0125 |
| according to | | | | | | |
| the invention- | | | | | | |
| 200 l/ha | | | | | | |

Dose rate: 0.5 kg/ha

The results show that recipe HB13 illustrative of the invention shows greater coverage at 10 L/ha spray volume as at 200 L/ha on textured leaves.

### EXAMPLE HB6: SL

TABLE HB36
Recipes HB14 and HB15.

| | | Recipe |
|---|---|---|
| | | HB15 |
| | Recipe | according |
| | HB14 | to the |
| Component (g/l) | reference | invention |
| Glyphosate K-salt (a) | 523 | 523 |
| Emulsogen ® EL 400 (c) | 10 | 10 |
| SILWET ® 806 (b) | 0 | 10 |
| Water (d) (add to 1 litre) | to | to |
| | volume | volume |

Dose rate: 3 L/ha

The method of preparation used was according to Method 5.

Spray Coverage Tests on Leaves

The leaf coverage was determined according to coverage method.

TABLE HB37
Spray deposit coverage and dose on textured leaves.

| | | | Leaf | Leaf | | |
|---|---|---|---|---|---|---|
| | | | coverage | coverage | | |
| | Leaf | Leaf | % | % | Organosilicone | Organosilicone |
| | coverage | coverage | chenopo- | chenopo- | surfactant | surfactant |
| | % | % | dium at | dium at | dose | dose |
| Recipe | rice at 0° | rice at 60° | 0° | 60° | g/ha | % w/v |
| Recipe HB14 not | 0.4 | 0.2 | 0.4 | 0.2 | 0 | 0 |
| according to the | | | | | | |
| invention - 10 l/ha | | | | | | |
| Recipe HB14 not | 0.7 | 0.3 | 1.6 | 0.3 | 0 | 0 |
| according to the | | | | | | |
| invention - 200 | | | | | | |
| l/ha | | | | | | |
| Recipe HB15 | 1.2 | 0.5 | 2.5 | 0.8 | 30 | 0.3 |
| according to the | | | | | | |
| invention - 10 l/ha | | | | | | |
| Recipe HB15 | 0.9 | 0.6 | 2.2 | 0.5 | 30 | 0.015 |
| according to the | | | | | | |
| invention - 200 | | | | | | |
| l/ha | | | | | | |

Dose rate: 3 L/ha

TABLE HB37a
Spray deposit coverage and dose on textured leaves.

| | Leaf | Leaf | Organo- | Organo- |
|---|---|---|---|---|
| | coverage | coverage | silicone | silicone |
| | % | % | surfactant | surfactant |
| | digitaria | digitaria | dose | dose |
| Recipe | at 0° | at 60° | g/ha | % w/v |
| Recipe HB14 not | 1.8 | 2 | 0 | 0 |
| according to the | | | | |
| invention-10 l/ha | | | | |
| Recipe HB14 not | 9 | 10.3 | 0 | 0 |
| according to the | | | | |
| invention-200 l/ha | | | | |
| Recipe HB15 | 2.3 | 2 | 30 | 0.3 |
| according to the | | | | |
| invention-10 l/ha | | | | |
| Recipe HB15 | 3 | 1 | 30 | 0.015 |
| according to the | | | | |
| invention-200 | | | | |
| l/ha | | | | |

Dose rate: 3 L/ha

The results show that recipe HB15 illustrative of the invention shows larger deposit sizes at 10 L/ha spray volume than at 200 L/ha and also compared to the reference recipe HB14.

Greenhouse

Efficacy Data

TABLE HB38
Biological efficacy on
Alopecurus myosuroides_(ALOMY).

| | | | | Recipe |
|---|---|---|---|---|
| | Rate | Rate | | HB15 |
| Spray | of SL | of | Recipe | according |
| volume | applied | of a.i. | HB14 | to the |
| l/ha | l/ha | g/ha | reference | invention |
| 200 | 3 | 1569 | 10 | 5 |
| 10 | 3 | 1569 | 72 | 99 |

TABLE HB38a
Biological efficacy on
Avena fatua (AVEFA).

| | | | | Recipe |
|---|---|---|---|---|
| | Rate | Rate | | HB15 |
| Spray | of SL | of | Recipe | according |
| volume | applied | of a.i. | HB14 | to the |
| l/ha | l/ha | g/ha | reference | invention |
| 200 | 3 | 1569 | 0 | 0 |
| 10 | 3 | 1569 | 60 | 72 |

The results in table HB37 and 37a show that recipe HB15 illustrative of the invention show greater efficacy at 10 L/ha spray volume as at 200 L/ha on different weeds and also compared to the reference recipe HB14.

### EXAMPLE HB7

TABLE HB39
Recipe HB16

| | Recipe HB16 |
|---|---|
| | according to |
| Component (g/l) | the invention |
| ACETOCHLOR (a) | 100 |
| EMULSOGEN EL 400 (c) | 40 |
| RHODACAL 60 BE (c) | 40 |
| SILWET 408 (b) | 40 |
| SOLVESSO 200 ND (d) | to volume |
| (add to 1 litre) | |

### EXAMPLE HB8

TABLE HB40
Recipe HB17

| | Recipe HB17 |
|---|---|
| | according to |
| Component (g/l) | the invention |
| BROMOXYNIL-OCTANOATE- | 100 |
| HEPTANOATE (a) | |
| EMULSOGEN EL 400 (c) | 41 |
| RHODACAL 60 BE (c) | 41 |
| SILWET 408 (b) | 40 |
| SOLVESSO 200 ND (d) | to volume |
| (add to 1 litre) | |

### EXAMPLE HB9

TABLE HB41
Recipe HB18

| | Recipe HB18 |
|---|---|
| | according to |
| Component (g/l) | the invention |
| IODOSULFURON-METHYL-SODIUM (a) | 10 |
| MEFENPYR-DIETHYL (a) | 25 |
| CASTOR OIL-40EO (c) | 50 |
| TRITON GR 7ME (c) | 150 |
| SILWET 408 (b) | 40 |
| SOLVESSO 200 ND (d) | to volume |
| (add to 1 litre) | |

Pipette Spreading Tests on Leaves

The deposit size was determined according to the coverage method.

TABLE HB42
Spray dilution droplet size and dose on non-textured leaves.

| | | | Organo- | Organo- |
|---|---|---|---|---|
| | | Deposit | silicone | silicone |
| | Deposit | area | surfactant | surfactant |
| | area mm\hat{ }2 | mm\hat{ }2 | dose | dose |
| Recipe | amaranthus | abutilon | g/ha | % w/v |
| Recipe HB16 | 21.5 | 18.9 | 40 | 0.4 |
| according to the | | | | |
| invention-10 l/ha | | | | |
| Recipe HB16 | 9.7 | 14.6 | 40 | 0.02 |
| according to the | | | | |
| invention- | | | | |
| 200 l/ha | | | | |
| Recipe HB17 | 8.4 | 19.7 | 40 | 0.4 |
| according to the | | | | |
| invention-10 l/ha | | | | |
| Recipe HB17 | 12.3 | 14.5 | 40 | 0.02 |
| according to the | | | | |
| invention- | | | | |
| 200 l/ha | | | | |
| Recipe HB18 | 13.9 | 16.7 | 40 | 0.4 |
| according to the | | | | |
| invention-10 l/ha | | | | |
| Recipe HB18 | 9.3 | 12.5 | 40 | 0.02 |
| according to the | | | | |
| invention- | | | | |
| 200 l/ha | | | | |

Formulations applied at 1 l/ha.

The results show that on non-structured leaves the coverage is in the most cases higher at 10 l/ha application volume.

TABLE HB43
Spray dilution droplet size and dose on textured leaves.

| | | Deposit | | Organo- | Organo- |
|---|---|---|---|---|---|
| | Deposit | area | Deposit | silicone | silicone |
| | area | mm\hat{ }2 | area | surfactant | surfactant |
| | mm\hat{ }2 | cheno- | mm\hat{ }2 | dose | dose |
| Recipe | rice | podium | digitaria | g/ha | % w/v |
| Recipe HB16 | 137.0 | 204.0* | 164.0 | 40 | 0.4 |
| according to the | | | | | |
| invention-10 l/ha | | | | | |
| Recipe HB16 | 59.7 | 34.7 | 79.9 | 40 | 0.02 |
| according to the | | | | | |
| invention- | | | | | |
| 200 l/ha | | | | | |
| Recipe HB17 | 172.0 | 241* | 220.0 | 40 | 0.4 |
| according to the | | | | | |
| invention-10 l/ha | | | | | |
| Recipe HB17 | 43.4 | 47.3 | 41.9 | 40 | 0.02 |
| according to the | | | | | |
| invention- | | | | | |
| 200 l/ha | | | | | |
| Recipe HB18 | 199.0 | 200.0* | 157.0 | 40 | 0.4 |
| according to the | | | | | |
| invention-10 l/ha | | | | | |
| Recipe HB18 | 48.0 | 112.4* | 99.8 | 40 | 0.02 |
| according to the | | | | | |
| invention- | | | | | |
| 200 l/ha | | | | | |

Formulations applied at 1 l/ha.

Numbers with asterisk mean that drops spread over the whole leave and the covered area (coverage) might be limited by the leaf area and not by lack of surfactants in the formulation.

The results show that recipes HB16, HB17 and HB18 illustrative of the invention shows greater coverage at 10 L/ha spray volume than at 200 L/ha on textured leaves.

### EXAMPLE HB10

TABLE HB44
Recipe HB19 and HB20

| | | | Recipe |
|---|---|---|---|
| | | | HB20 |
| | | Recipe | according |
| | | HB19 | to the |
| Component (g/l) | | reference | invention |
| TRIAFAMONE | (a) | 70.00 | 70.00 |
| Silwet L 77 | (b) | 0.00 | 40.00 |
| ATLOX 4913 | (c) | 32.40 | 32.40 |
| ATLOX 4894 | (c) | 21.60 | 21.60 |
| 1.2-PROPYLENE GLYCOL | (c) | 54.00 | 54.00 |
| Silcolapse ® 454 | (c) | 2.16 | 2.16 |
| Proxel ® GXL | (c) | 1.94 | 1.94 |
| Kathon ® CG/ICP | (c) | 0.86 | 0.86 |
| RHODOPOL ® 23 | (c) | 4.32 | 4.32 |
| Na2HPO4 (Buffer solution pH = 7) | (c) | 1.5 | 1.5 |
| NaH2PO4 (Buffer solution pH = 7) | (c) | 0.8 | 0.8 |
| Water (d) (add to 1 litre) | (c) | to | to |
| | | volume | volume |

Pipette Spreading Tests on Leaves

The leaf deposit size was determined according to the coverage method.

TABLE HB45
Spray dilution droplet size and
dose on non-textured leaves.

| | | Super- | Super- |
|---|---|---|---|
| | Deposit | spreading | spreading |
| | area | surfactant | surfactant |
| | mm\hat{ }2 | dose | dose |
| Recipe | apple | g/ha | % w/v |
| Recipe HB19 not | 8.6 | 0 | 0 |
| according to the | | | |
| invention-10 l/ha | | | |
| Recipe HB19 not | 6.8 | 0 | 0 |
| according to the | | | |
| invention-200 l/ha | | | |
| Recipe HB20 | 69.8 | 40 | 0.4 |
| according to the | | | |
| invention-10 l/ha | | | |
| Recipe HB20 | 15.5 | 40 | 0.02 |
| according to the | | | |
| invention-200 l/ha | | | |

Formulations applied at 1 l/ha.

The results show that on non-structured leaves the deposit size is higher at lower water application volume.

TABLE HB46
Spray dilution droplet size and
dose on textured leaves.

| | | Super- | Super- |
|---|---|---|---|
| | Deposit | spreading | spreading |
| | area | surfactant | surfactant |
| | mm\hat{ }2 | dose | dose |
| Recipe | soybean | g/ha | % w/v |
| Recipe HB19 not | 6.4 | 0 | 0 |
| according to the | | | |
| invention-10 l/ha | | | |
| Recipe HB19 not | 3.9 | 0 | 0 |
| according to the | | | |
| invention-200 l/ha | | | |
| Recipe HB20 | 85.5 | 40 | 0.4 |
| according to the | | | |
| invention-10 l/ha | | | |
| Recipe HB20 | 18.7 | 40 | 0.02 |
| according to the | | | |
| invention-200 l/ha | | | |

The results show that recipe HB20 illustrative of the invention shows larger deposit sizes at 10 L/ha spray volume than at 200 L/ha and compared to the reference recipe HB19.

1. An agrochemical formulation comprising
a) one or more active ingredients selected from the group of agrochemically applied herbicides,
b) one or more organosilicone based surfactants,
c) one or more other formulants, and
d) carrier to volume,
wherein b) is present in an amount from 0.5 to 15% by weight.

2. The agrochemical formulation according to claim 1, wherein b) is a polyalkyleneoxide modified heptamethyltrisiloxane.

3. The agrochemical formulation according to claim 1, wherein a) is present in an amount from 0.5 to 25% by weight, preferably from 5.5 to 20% by weight, and most preferably from 1 to 20% by weight.

4. The agrochemical formulation according to claim 1, wherein the herbicide is selected from the group consisting of acetochor, bromoxynil-ocatanoate, bromoxynil-heptanoate, bromoxynil-ocatanoate-heptanoate, fenoxaprop-P-ethyl, glyphosate, glyphosate salts, iodosulfuron-methyl-sodium, iodosulfuron, indaziflam, mesosulfuron-methyl, mesosulfuron-methyl-sodium, tembotrione, thiencarbazone-methyl and triafamone.

5. The agrochemical formulation according to claim 1, wherein b) is present in an amount from 0.5 to 15% by weight, preferably from 0.75 to 12% by weight, and more preferably from 1 to 10% by weight.

6. The agrochemical formulation according to claim 1, wherein c) is present in an amount from 0.5 to 65% by weight, preferably from 1 to 49.5% by weight, and more preferably from 2 to 37.5% by weight.

7. The agrochemical formulation according to claim 1, wherein component c) comprises at least one non-ionic surfactant and/or ionic surfactant.

8. The agrochemical formulation according to claim 1, wherein component c) comprises at least one non-ionic surfactant (c1) and/or ionic surfactant, one rheological modifier (c2), one antifoam substance (c3), and one further formulant (c4).

9. The agrochemical formulation according to claim 8, wherein c1 to c4 are present in an amount from:
c1) 2 to 37.5% by weight,
c2) 0.1 to 20% by weight,
c3) 0.05 to 5% by weight, and
c4) 0.1 to 20% by weight.

10. The agrochemical formulation according to claim 1, wherein the formulation is applied at a spray volume of between 1 and 20 l/ha, preferably between 2 and 15 l/ha, and more preferably between 5 and 15 l/ha.

11. A method of applying the agrochemical formulation according to claim 1 onto crops, wherein the formulation is applied at a spray volume of between 1 and 20 l/ha, preferably between 2 and 15 l/ha, and more preferably between 5 and 15 l/ha.

12. The method according to claim 11, wherein the applied amount of a) to the crop is between 2 and 250 g/ha, preferably between 5 and 225 g/ha, and more preferably between 10 and 200 g/ha.

13. The method according to claim 11, wherein the organosilicone-surfactant of b) is preferably applied from 10 g/ha to 100 g/ha, more preferably from 20 g/ha to 80 g/ha, and most preferably from 40 g/ha to 60 g/ha.

14. The method according to claim 11, wherein the formulation is applied on plants, weeds or crops with textured leaf surfaces.

15. A method of controlling weeds, comprising applying the agrochemical formulation according to claim 1, wherein the formulation is applied by an unmanned aerial vehicle (UAV), an unmanned guided vehicle (UGV), or a pulse-width-module (PWM).

16. A method of controlling weeds, comprising contacting the weeds, soil, areas, and environments in which the weeds grow or could grow, but also comprising contacting materials, plants, seeds, soil, surfaces or spaces which are to be protected from infestation by weeds, with an effective amount of the agrochemical formulation according to claim 1, characterized in that the formulation is applied by an unmanned aerial vehicle (UAV), an unmanned guided vehicle (UGV), or a pulse-width-module (PWM).
